(19) United States
(12) Patent Application Publication
(10) Pub. No.: US 2016/0300265 A1
(43) Pub. Date: Oct. 13, 2016

(54) CAPPING CAMPAIGN FREQUENCY OR SPEND PER USER ACROSS MULTIPLE DEVICES OR PUBLISHERS

(71) Applicant: Adobe Systems Incorporated, San Jose, CA (US)

(72) Inventors: Praveen Kumar Goyal, Noida (IN); Ashish Duggal, Ashok Nagar (IN); Anuj Jain, Dwarka (IN)

(21) Appl. No.: 14/682,816

(22) Filed: Apr. 9, 2015

(51) Int. Cl. G06Q 30/02

(52) U.S. Cl. CPC G06Q 30/0257; G06Q 30/0273; G06Q 30/0267

(57) ABSTRACT

The present disclosure is directed toward systems and method for limiting frequency of marketing content provided to users. For example, systems and methods described herein involve tracking a total quantity of marketing content received by a particular user for a marketing campaign. In particular, the systems and method described herein involve tracking a total quantity of marketing content received by a user across multiple devices and/or from multiple publishers. The systems and methods further involve preventing the user from receiving marketing content beyond a maximum allowable quantity of marketing content for the user within a predetermined period of time.

### CROSS REFERENCE TO RELATED APPLICATIONS

N/A

### BACKGROUND

1. Technical Field

One or more embodiments described herein relate generally to communicating electronic marketing content. More specifically, one or more embodiments relate to limiting frequency of providing marketing content to a user.

2. Background and Relevant Art

The Internet is an increasingly popular mechanism for delivering electronic content. For example, a marketer can launch a marketing campaign for a particular product or brand by way of advertising via electronic platforms (websites, emails, native mobile applications, etc.) provided by various publishers. Marketing campaigns are an effective tool for promoting awareness of a particular product or brand and boosting sales.

Online marketing typically includes providing advertisements to users by way of various publisher platforms. For example, a content publisher of a website generally receives advertisements (e.g., videos, banners, stickers) associated with a product and provides the advertisement to a viewer that accesses the website using an electronic device. Typically, a marketer or other provider of the advertisements pays the content publisher based on the number of advertisements provided, by the number of clicks, or the number of conversions.

While online marketing is a cheap and effective way to disseminate information about a particular brand or product, conventional online marketing is often inexact and inefficient. For example, online marketing typically involves providing advertising content to electronic devices based on attributes known about the electronic device, the user of the electronic device, or the electronic publisher (e.g., website). Unfortunately, conventional online marketing often results in oversaturation of advertisements. For example, a viewer that visits a particular website over and over often receives the same advertisements for the same products over and over again. This cumulative marketing approach often results in an ineffective use of a marketing budget. Furthermore, providing the same advertisement to an otherwise interested viewer over and over again often causes the viewer to become annoyed with a particular product or brand. Thus, conventional marketing techniques can often produce the opposite result of raising a positive awareness of a brand, and instead annoy potential customers by turning them off to a product.

More and more users now access the Internet using a greater number of devices. For example, it is not uncommon for a user to access the Internet using a work computer, a personal home computer, a laptop, a tablet, and a cell phone. Many conventional marketing schemes target advertisements based on client devices. In particular, conventional marketing schemes often user cookies, which are device specific to target advertisements. As such, a user may receive the advertisements from the same marketing campaign using a number of different devices as the cookies for each device as different. As mentioned, such over targeting can reduce the efficiency of the marketing campaign. To compound the issue, the marketer may be led to believe that many different users were targeted when in reality a single user may have received the advertisements using multiple client devices.

Furthermore, marketers often advertise across different publisher platforms. For example, a marketer may choose to advertise on a website, a social media site, and a mobile application. Publishers, however, generally avoid sharing information with other publishers. The inability or unwillingness of publishers to share information often results in viewers receiving the same advertisements over and over across different publisher platforms. For example, where a marketer allocates a marketing budget to different publishers to raise awareness of a particular product, the content publishers often provide the same advertisements to the same viewers over and over again. This cumulative marketing approach often oversaturates viewership with identical advertisements resulting in an ineffective use of a marketing budget.

Thus, current methods of online marketing include several disadvantages that result in ineffective marketing and ineffective use of marketing budgets.

### SUMMARY

One or more embodiments described herein provide benefits and/or solve one or more of the foregoing and other problems in the art with systems and methods that enable marketers to limit frequency of marketing content. For example, one or more embodiments described herein involve methods and systems for limiting frequency of marketing content from a marketing campaign provided to a particular user. In particular, systems and methods described herein involve tracking marketing content for the marketing campaign provided to the user across multiple devices. The systems and methods can then limit the amount of marketing content from the marketing campaign provided to the user irrespective of the client device used by the user.

In addition to limiting frequency of marketing content received by a user across multiple devices, systems and methods described herein can involve limiting frequency of marketing content for a marketing campaign provided to a user by multiple publishers. In particular, systems and methods described herein involve tracking a quantity of marketing content for the marketing campaign provided to the user via multiple publishers. The systems and methods can then limit the amount of marketing content from the marketing campaign provided to the user irrespective of the content publisher providing the marketing content.

Thus, one or more embodiments for efficient use of a marketing budget by targeting a greater number of users. In particular, by capping the frequency or marketing budget spent on particular users, one or more embodiments reach a greater number of users. Thus, one or more embodiments can increase the efficiency of a marketing campaign without necessarily raising the costs.

Additional marketing features and advantages will be set forth in the description which follows, and in part will be obvious from the description, or may be learned by the practice of such exemplary embodiments. The marketing features and advantages of such embodiments may be realized and obtained by means of the instruments and combinations particularly pointed out in the appended claims. These and other marketing features will become more fully apparent from the following description and appended claims, or may be learned by the practice of such exemplary embodiments as set forth hereinafter.

### BRIEF DESCRIPTION OF THE DRAWINGS

In order to describe the manner in which the above recited and other advantages and marketing features, a more particular description will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments and are not therefore to be considered to be limiting of its scope, various embodiments will be described and explained with additional specificity and detail through the use of the accompanying drawings in which:

FIG. 1 illustrates a block diagram of an environment in which a marketing system can operate in accordance with one or more embodiments;

FIG. 2 illustrates a schematic diagram of the marketing system of FIG. 1 in accordance with one or more embodiments;

FIGS. 3A-3B illustrates a flow diagram of interactions between multiple client devices, a marketing system, and content publishers in accordance with one or more embodiments;

FIG. 4A-4B illustrates a flow diagram of interactions between a client device, a marketing system, and multiple content publishers in accordance with one or more additional embodiments;

FIG. 5 illustrates a flow chart of a series of acts in a method of limiting frequency of marketing content for a marketing campaign provided to a user via multiple client devices in accordance with one or more embodiments;

FIG. 6 illustrates a flow chart of a series of acts in a method of limiting frequency of marketing content for a marketing campaign provided to a user via multiple publishers in accordance with one or more embodiments; and

FIG. 7 illustrates a block diagram of an exemplary computing device in accordance with one or more embodiments.

### DETAILED DESCRIPTION

One or more embodiments described herein include a marketing system that limits marketing content frequency provided to a recipient in a digital medium environment. In one or more embodiments, the marketing system can more effectively target an audience of a marketing campaign by managing a quantity of marketing content received by a specific user. In particular, the marketing system can track marketing content received by the user across different devices and across different publishers. The marketing system can use the tracked data to determine how much marketing content for a marketing campaign the user has received and then control further distribution of marketing content from the marketing campaign to the user based on frequency rules associated with the marketing campaign.

Thus, the marketing system can prevent oversaturation of marketing content for individual users by limiting a quantity of marketing content for a marketing campaign received by specific users. In particular, as described above, the marketing system can track and update a total quantity of marketing content received by a specific user for a marketing campaign (e.g., across multiple client devices and multiple publishers). In addition, the marketing system can compare the updated quantity of marketing content to a maximum allowable quantity of marketing content received by the user for the marketing campaign. If the user has received the maximum allowable quantity of marketing content for the marketing campaign, the marketing system can prevent the user from receiving additional marketing content for the marketing campaign. Capping the quantity of marketing content for the specific user can promote a brand or product to various users while avoiding burnout or annoyance due to redundant advertising.

As mentioned, the marketing system can track and limit marketing content frequency for a marketing campaign for an individual user across multiple client devices. In particular, the marketing system can identify unique users irrespective of the client device that the user unique user uses. Thus, the marketing system can track how many advertisements and what advertisements the unique user has been served for a given marketing campaign. The marketing system can then serve additional advertisements from the marketing campaign or prevent distribution of marketing content from the marketing campaign in response to future advertisement calls for the user based on frequency rules associated with the campaign.

More specifically, the marketing system can identify unique users based on a number of different techniques. For example, the marketing system can identify unique users based on a custom visitor ID. In particular, certain websites and content providers require a user to provide unique login credentials (user ID and password) to access the website or content. Once the user has logged in, any advertisements calls can include the user ID or a hash thereof The marketing system can use this custom visitor ID to uniquely identify the user irrespective of whether the user is on her mobile phone, tablet, or computer.

In addition to the custom visitor ID, the marketing system can track unique device IDs. For instance, the marketing system can identify devices based on cookies, subscriber ID header (e.g., a hashed device phone number or other unique device identifiers), or an IP address in combination with a user agent. The marketing system can then identify that a first custom visitor ID was used on a first client device. The marketing system can associate the first custom visitor ID and the first client device ID in a profile. The marketing system then may detect that a second custom visitor ID is used on the first client device. Based on this connection, the marketing system can deduce that the first custom visitor ID and the second custom visitor ID are associated with the same unique user.

This information can allow the marketing system to track and limit marketing content frequency for marketing content provided to the user from multiple publishers in addition to managing marketing content across multiple devices. In particular, the first custom visitor ID may be associated with a first content publisher and the second custom visitor ID may be associated with a second content publisher. As mentioned above, based on the first and second custom visitor IDs being used on the same client device, the marketing system can link the two custom visitor IDs. As such, the marketing system can track and identify marketing content served to the user irrespective of whether the user is accessing content from the first content publisher or the second content publisher.

Furthermore, the marketing system can control content distribution across multiple content publisher without requiring that the content publishers share information with each other or otherwise compromise publisher information. For example, the marketing system can maintain and manage profiles associated with different publishers as well as individual users. When a user logs into a content publisher's website, the content publisher can assign a user identifier for the user and the marketing system can associate the user identifier with the corresponding user. Additionally, each time the user receives marketing content, the marketing system can receive a tracking call that identifies the client device, user, publisher, and advertisement provided to the user. With each received tracking call, the marketing system can update a quantity of marketing content received by the user as well as a quantity of marketing content provided by respective publishers and limit the quantity of marketing content for a particular marketing campaign received by the user from multiple publishers.

The ability to track marketing content provided to a user across multiple device or content publishers can provide a marketer to control the value, amount, or total exposure of a marketing campaign to each user. For example, a marketing campaign manager can control maximum cap on advertisement dollars they want to spend on a single user across all devices that the user operates. Additionally, the marketing campaign manager can set a maximum individual cap on individual advertisements in the campaign. In particular, the marketing campaign manager may not want to cap a user's exposure to a marketing campaign only via overlay or pop-ups advertisements. Thus, the marketing campaign manager can specify that a maximum number of overlay advertisements that a user can receive is 5. Hence, the user may have to see one or more video advertisements in combination with 0 to 5 overlay advertisements before reaching the maximum individual cap. One will appreciate that the foregoing frequency controls can apply both across multiple client devices and multiple content publishers.

In a first example embodiment, a marketing system can implement frequency capping of marketing content for a marketing campaign delivered to a user of multiple client devices. For example, a user can interact with a first client device and a second client device and receive marketing by way of the first client device and/or the second client device. In one or more embodiments, the first client device is a different type of client device than the second client device. As an example, the first client device may be a personal computer or a tablet and the second client device may be a mobile device (e.g., a smartphone).

In one implementation, the marketing system can launch a marketing campaign for a new cell phone. In particular, a goal of the marketing campaign may include apprising users about an upcoming launch event for the new cell phone. Specifically, the marketing campaign may include two video advertisements including a first video advertisement in which an athlete endorses the new cell phone and a second video advertisement in which a Hollywood actor endorses the cell phone. The marketing campaign may also include some overlay advertisements. Additionally, the first video may have a $100 cost per thousand (CPM) viewers (e.g., 10 cents per viewer) while the second video has a $200 CPM (e.g., 20 cents per viewer). In this example, each advertisement may further include individual targeting information such as a demographic of users who are more relevant to each advertisement as well as specific websites that more relevant to a specific advertisement.

In launching the campaign, the marketing system may receive, identify, or otherwise determine a per-user budget of one dollar. As such, the marketing, merchant, or other organization may only wish to provide one dollar worth of advertising to any individual user on a combination of videos, overlays, or other advertisements that make up the marketing campaign. Additionally, in one or more embodiments, the marketing campaign may indicate that an entire budget for a particular user should not be spent on showing only a single advertisement (or a single type of advertisement) within the marketing campaign and that a user should be shown at least two video advertisements from the campaign.

In the above example, the user may use the first client device (e.g., a tablet) to log onto a website associated with a content publisher. As the user watches a movie provided by the content publisher, the user may receive the video advertisement featuring the Hollywood actor four times promoting the new cell phone. Each time the first client device receives the first video advertisement, the first client device may provide a tracking call that indicates the user, client device, and the first video advertisement to the marketing system. Because the first video costs 20 cents per view, the marketing system may determine that the total quantity of marketing content for the user is equal to 80 cents.

In the same example, the user may log off the first client device and board a train to go to work. While on the train, the user may use the second client device (e.g., a mobile phone) to log onto the same or different website associated with the same publisher and watch a sports video. During the session, the user may receive the second video advertisement featuring the athlete two times and provide a tracking call indicating that the user has viewed the second video advertisement after each view. Because the second video advertisement costs 10 cents per view, the marketing system may determine that the total quantity of marketing content equals one dollar after two views on the second client device.

The marketing system can identify that the user has received the maximum allowable quantity of marketing content for the marketing campaign between the first client device and the second client device and perform one or more actions to prevent the user from receiving additional marketing content for the same marketing campaign. For example, the marketing system may assign the user to a user segment associated with a campaign trait that indicates the user has received the maximum allowable quantity of marketing content for the marketing campaign. Accordingly, when the marketing system or ad server receives any requests from a client device or content server for marketing content, the marketing system may prevent any marketing content for the marketing campaign from being delivered from the ad server.

In a second example embodiment, the marketing system can implement frequency capping of marketing content for a marketing campaign delivered to a user from multiple publishers at a single client device or multiple client devices. For example, a user can receive marketing content from a first publisher and a second publisher. For ease in explanation, the second example embodiment may include delivering marketing content using a single client device. Nevertheless, other embodiments may include features and functionality of frequency capping marketing content for a marketing campaign delivered to a user from multiple publishers and between multiple client devices.

In one implementation, the marketing system can launch a marketing campaign for a smart phone with a goal of apprising users about an upcoming launch. Additionally, a marketer, merchant, or other organization may wish to run the marketing campaign across different websites associated with different publishers while also limiting the quantity of marketing content distributed to individual users. As such, the marketing system can include features and functionality to limit a total quantity of marketing content to an individual user across multiple publisher platforms.

For example, a user can log onto a first website associated with the first publisher. As the user browses the first website, the user may receive three advertisements for the new smart phone in conjunction with electronic media provided on the first website. After some time, the user may navigate to a second website associated with the second publisher and receive the same or different advertisement for the new smart phone in conjunction with electronic media provided on the second website. Similar to other embodiments described herein, the marketing system may determine that the user has received a maximum allowable quantity of marketing content for the marketing campaign across the different websites and prevent the user from receiving additional marketing content in excess of the maximum allowable quantity.

As used herein “marketing content” or “electronic marketing content” refers to advertisements or other forms of digital data related to marketing that may be transmitted over a communication network. For example, marketing content can include, but is not limited to, digital media (e.g., audio, video, images), electronic documents, electronic messages, electronic advertisements, or any other digital data or combination of digital data. As an example, marketing content or advertising content can refer to a video advertisement provided to a user via a website. Other examples of marketing content or advertising content can refer to banners, overlays, pop-ups, emails, texts, audio clips, etc.

As used herein, a “content publisher” or “content provider” refers to a provider of digital media. For example, a content publisher may refer to a user, organization, or entity that provides a website, television channel, radio channel, or other communication channel over which digital media is provided to a user. More specifically, a content publisher can include a website provider that provides digital media to any user that logs onto the website. Alone similar lines, a content publisher can include a native application on a mobile device (e.g., mobile phone or tablet). In one or more embodiments, a content publisher can provide marketing content in conjunction with digital media. For example, a content publisher can stream a video advertisement or other marketing content by way of a website or native application managed by the content publisher.

As used herein, a “marketing campaign” refers to a set of one or more advertisements sharing one or more common characteristics. Specifically, such common characteristics can include similar content (e.g., directed toward the same product, line of products, or brand), a similar theme (e.g., a particular sale, products for a particular season), or features directed toward a particular audience. For example, a marketing campaign can include one or more related advertisements that are each directed towards a single brand, product, or service. Alternatively, a marketing campaign can include advertisements that are directed towards different products or features of a line of products or services. For example, a marketer can configure a marketing campaign including a plurality of advertisements for a single product or service. Additionally, in one or more embodiments, the marketing campaign can include different types of advertisements (e.g., videos, banners, pop-ups, audio clips) that relate to a particular product or service.

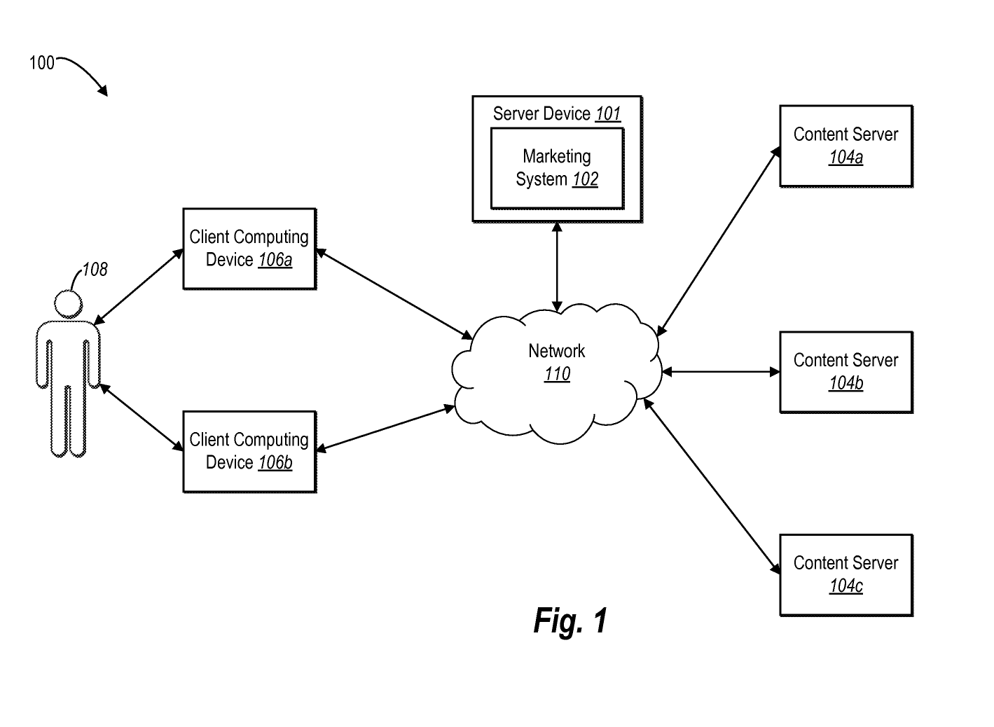

FIG. 1 illustrates a schematic diagram of a system 100 in which a marketing system 102 can function in accordance with one or more embodiments. As illustrated in FIG. 1, the system 100 may include a marketing system 102, one or more content servers 104a-b, one or more client devices 106a-b, and a corresponding user 108 of the client devices 106a-b. In some embodiments, the system 100 may include a service device 101 upon which the marketing system 102 is implemented. Further, each of the marketing system 102, content servers 104a-c, and client devices 106a-b may communicate over a network 108. Although the system 100 of FIG. 1 illustrates a particular arrangement of the service device 101, marketing system 102, content servers 104a-c and client devices 106a-b, the system can include alternative configurations. For example, one or more client devices 106a-b and/or one or more content servers 104a-c may directly communicate with each other or with the marketing system 102 by passing the network 108.

While FIG. 1 illustrates only a few content servers 104a-c, the system 100 can include any number of content servers 104a-c corresponding to one or more content publishers. In one or more embodiments, each content server 104a-c may correspond to a different publisher of digital media. For example, each content server 104a-c may host or otherwise provide digital media for one or multiple websites associated with a respective publisher. Additionally, while one or more embodiments described herein refers specifically to delivering digital media and marketing content to a user 108 by way of one or more websites hosted by a content server, a content server may refer to one or multiple devices associated with a content publisher that provides digital media and/or marketing content by way of various types of communications channels (e.g., website, television channel, radio channel, etc.). Additionally, in one or more embodiments, a content publisher can provide multiple forms of digital media and marketing content to the user 108 as part of a single marketing campaign and/or using multiple content servers associated with the same publisher.

Further, while FIG. 1 illustrates only a few client devices 106a-b and a corresponding user 108, the system 100 can include any number of client devices corresponding to the user 108 or, alternatively, multiple users that utilize common devices. Further, the marketing system 102 and/or the content servers 104a-c can communicate digital media and/or marketing content to the user 108 via one or more of the client devices 106a-b. Additionally, although FIG. 1 illustrates only one marketing system 102, the system 100 can include one or more additional marketing systems corresponding to different marketers, merchants, organizations, or individual users. As an example, different marketers may communicate with the client devices 106a-b and content providers 104a-c by way of different marketing systems associated with different marketers.

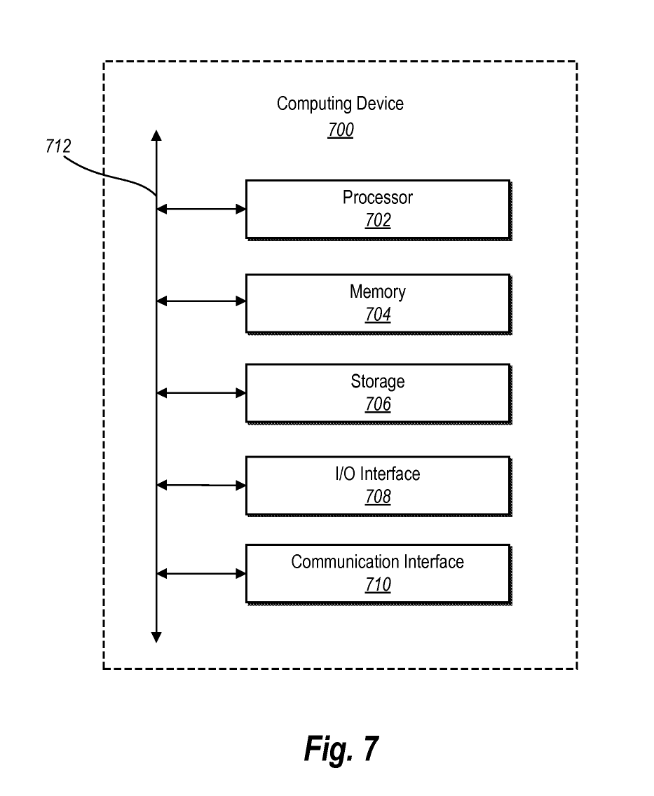

Furthermore, as shown in FIG. 1, in one or more embodiments, the user 108 can interact with one or more of the client devices 106a-b. In particular, the user 108 can use the client devices 106a-b to communicate with the marketing system 102. Additionally, each of the client devices 106a-b may be similar or different types of client devices. Examples of client devices 106a-b can include, but are not limited to, mobile devices (e.g., smartphones, tablets), laptops, desktops, smart TVs, set-top boxes, or other type of computing device, such as those described below in connection with FIG. 7.

Additionally, as stated above, the marketing system 102, content servers 104a-c, and client devices 106a-b can communicate with other systems and devices within the system 100 through the network 108. In one or more embodiments, the network 108 may include the Internet or World Wide Web. Nevertheless, various other types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Additional networks and network marketing features are described below in connection with FIG. 7.

As mentioned above, the marketing system 102 can communicate with a user 108 and/or a content publisher by way of the network 110. In one or more embodiments, the marketing system 102 may act as a marketing source from which marketing content originates and/or from which a marketing campaign is launched (e.g., on behalf of a merchant, user, business, or other source). Alternatively, the marketing system 102 can perform one or more functions described herein and provide information (e.g., user information, publisher information, marketing campaign information) to a marketing source to facilitate providing marketing content to one or more client devices 106a-b. Nevertheless, as used herein, the marketing system 102 may refer to a marketing source, a system acting on behalf of a marketing source, or a system that provides additional information to a marketing source or content server that provides digital media and/or marketing content to client devices 106a-b.

In one or more embodiments, the marketing system 102 can maintain information associated with a user 108 based on information provided to the marketing system 102. For example, the marketing system 102 can observe, track, or otherwise receive information (e.g., from one or more third-party websites) about the user 108 based on actions performed by the user 108 using a client device.

In addition to receiving and maintaining information associated with the user 108, the marketing system 102 can also maintain information associated with one or more publishers based on information provided to the marketing system 102 by the content publishers. For example, the marketing system 102 can register a content publisher and maintain a content publisher profile based on information provided to the marketing system 102 when registering the content publisher. In one or more embodiments, the marketing system 102 can build a content publisher profile based on information provided to the marketing system 102 by the content publisher. Additionally, the marketing system 102 can receive information from one or more client devices 106a-b about the content publisher based digital media or marketing content provided to the user 108 via one or more content servers 104a-c.

The marketing system 102 can further launch a marketing campaign by providing marketing content to one or more content servers 104a-c to be delivered to a user 108 via one or multiple client devices 106a-b. In particular, the marketing system 102 can provide marketing content (e.g., digital advertisements) to the content servers 104a-c associated with different publishers to provide marketing content for a marketing campaign to a user 108 in conjunction with digital media. For example, the marketing system 102 can provide one or more video advertisements for a marketing campaign to each of the content servers 104a-c to be delivered to a user 108 when the user 108 accesses a website hosted by one of the content servers 104a-c.

The marketing system 102 can further track a quantity of marketing content received by a user 108 over a period of time. In particular, the marketing system 102 may receive a tracking call from a client device confirming receipt of marketing content by the user 108 each time the user 108 streams, displays, selects, or otherwise consumes an advertisement for a marketing campaign via one of the client devices 106a-b. In response to receiving the tracking call, the marketing system 102 can update a quantity of marketing content received by the user 108 for a particular marketing campaign. In one or more embodiments, the marketing system 102 tracks the quantity of marketing content by facilitating installation of a plugin on the client devices 106a-b that causes the client devices 106a-b to make a tracking call in response to an embedded Uniform Resource Locator (URL) each time marketing content for the marketing campaign is presented to the user 108. Further, the tracking call and/or tracking element can include an indication of the marketing content, the user 108, the client device and/or a quantity of marketing content received by the user 108.

In addition to tracking a quantity of marketing content received by the user 108, the marketing system 102 may further limit a total quantity of marketing content provided to the user 108 over a period of time. In particular, the marketing system 102 may determine or otherwise identify a maximum allowable quantity of marketing content that the user 108 is allowed to consume for a particular marketing campaign and perform one or more actions to prevent the user 108 from receiving marketing content in excess of the maximum allowable quantity. For example, the marketing system 102 may detect that the user 108 has received a maximum allowable quantity and cease providing marketing content for the marketing campaign to the content servers 104a-b. As an alternative, the marketing system 102 can communicate information to the client devices 106a-b, content servers 104a-c, ad server (not shown) or other components within the system 100 that the user 108 has received a maximum quantity of marketing content for the marketing campaign as well as instructions to prevent any additional marketing content for the campaign from being delivered to the user 108.

In addition to tracking and limiting marketing content for a particular marketing campaign provided to the user 108, the marketing system 102 can further monitor, track, and/or otherwise manage a quantity of marketing content that one or more publishers provide to the user 108. In particular, the marketing system 102 can maintain a quantity of marketing content provided to the user 108 by each of the content servers 104a-c. Specifically, in one or more embodiments, the marketing system 102 can receive a tracking call from a client device receiving the marketing content that identifies the content publisher and/or content server that delivered the marketing content to the client device. Additionally or alternatively, the marketing system 102 can receive a tracking call or other indication from the content server that marketing content has been delivered to the user 108 from a specific content server.

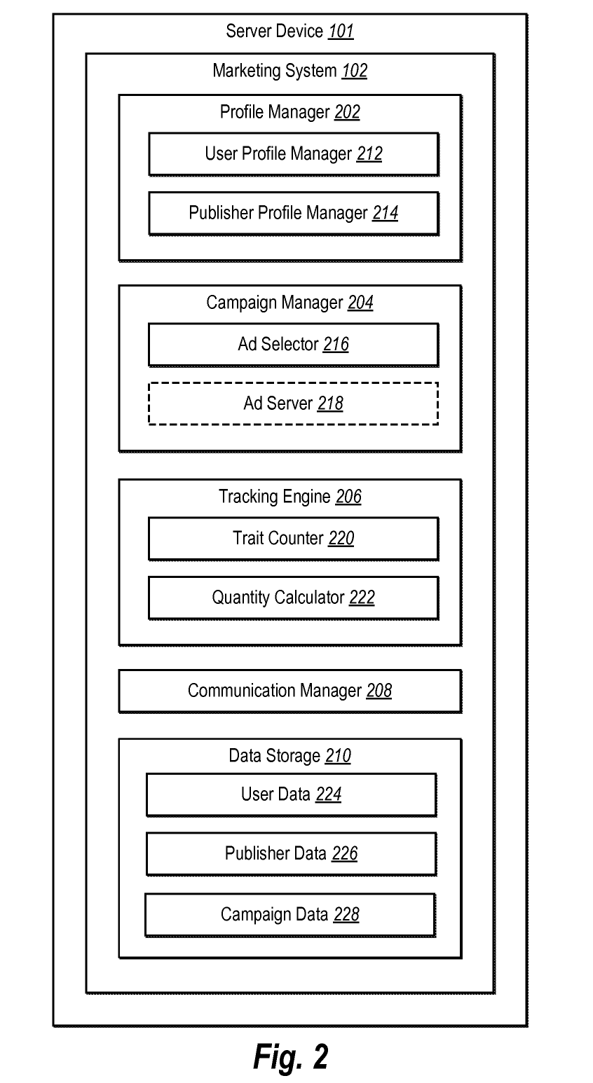

FIG. 2 illustrates a schematic diagram illustrating an example embodiment of the marketing system 102. In one or more embodiments, the marketing system 102 can include a profile manager 202, a campaign manager 204, a tracking engine 206, a communication manager 208, and data storage 210. Although the diagram illustrated in FIG. 2 shows the components 202-210 to be separate, any of the components 202-210 may be combined into fewer components, such as into a single facility module, or divided into more components as may serve one or more embodiments. In addition, the components 202-210 may be located on, or implemented by, one or more servers or other computing devices, such as those described below in relation to FIG. 7. For example, as shown in FIG. 2, the marketing system 102 may be implemented on a server device 101.

The components 202-210 can comprise software, hardware, or both. For example, the components 202-210 can comprise one or more instructions stored on a computer readable storage medium and executable by a processor of one or more computer devices. When executed by the one or more processors, the computer-executable instructions of the marketing system 102 can cause a computing device(s) to perform the methods described herein. Alternatively, the components 202-210 can comprise hardware, such as a special-purpose processing device to perform a certain function. Additionally or alternatively, the components 202-210 can comprise a combination of computer-executable instructions and hardware.

Furthermore, the components of the marketing system 102 may, for example, be implemented as a stand-alone application, as a module of an application, as a plug-in for applications including image processing applications, as a library function or functions that may be called by other applications such as image processing applications, and/or as a cloud-computing model. Thus, the components of the marketing system 102 may be implemented as a stand-alone application, such as a desktop or mobile application (e.g., an application running on a personal computing device). Additionally or alternatively, the components of the marketing system 102 may be implemented in any application that allows users to modify documents, including but not limited to ADOBE PRIMETIME, ADOBE AUDIENCEMANAGER and AUDITUDE. “ADOBE,” “ADOBE PRIMETIME,” “ADOBE AUDIENCEMANAGER,” and “AUDITUDE” are registered trademarks of Adobe Systems Incorporated in the United States and/or other countries.

In one or more embodiments, the marketing system 102 can perform various tasks and functions that provide tools and services to one or more merchants and/or marketers. For example, the marketing system 102 can communicate with one or more content servers 104a-c to launch a marketing campaign (e.g., for a product or service) by facilitating communication of marketing content to content servers 104a-c that in turn deliver the marketing content in conjunction with digital media to a user 108. Further, the marketing system 102 can track a quantity of marketing content for a marketing campaign provided to a specific user 108 across multiple devices and/or across different publishers. Using the tracked quantity of marketing content, the marketing system 102 can further prevent the user 108 from receiving more than a predetermined quantity of marketing content for the marketing campaign from one or multiple publishers.

In realizing features and functionality of the marketing system 102, a profile manager 202 can manage information associated with one or more users and one or more publishers. In particular, the profile manager 202 can include a user profile manager 212 that manages one or more user profiles for users of the marketing system 102. For example, the user profile manager 212 can maintain a user profile associated with the user 108 that includes various types of information about the user 108 that the marketing system 102 may use in regulating a quantity of marketing content for a particular marketing campaign that is provided to the user 108. In one or more embodiments, the user profile manager 212 can provide user information to one or more content servers 104a-c, as will be discussed in greater detail below.

The user profile manager 212 can collect information associated with a user 108 in a variety of ways. For example, the marketing system 102 can collect user information over time by monitoring one or more client devices 106a-b and generating additional user information for the user 108 based on user behavior, online history, purchases, or other actions performed by the user 108 using one or more client devices 106a-b. In one or more embodiments, one or more client devices 106a-b can provide user profile information to the marketing system 102. Additionally or alternatively, one or more content servers 104a-c can provide user profile information to the marketing system 102 (e.g., in response to detecting that a user 108 logs onto a website associated with a particular content server).

Accordingly, the user profile manager 202 can maintain a profile for the user 108 that includes various types of information associated with the user 108. For example, a user profile can include personal information. In one or more embodiments, personal information may include, but is not limited to, demographic information (e.g., age, gender, race), location information, profession, interests, hobbies, or other information that is personal or particular to the user 108. The marketing system 102 can continue to build the user profile using additional personal information collected about the user 108 over time.

The user profile can also include with the user 108. For example, the user profile manager 212 can maintain login credentials and account information for an account created and hosted by the marketing system 102. The user profile manager 212 can associate various client devices, user profiles, custom visitor IDs, and other identifying information with a user. For example, when a user logs into a content publisher platform (e.g., website or mobile device application) using a first client device (e.g., mobile phone), the content publisher can assign the user a publisher specific custom visitor ID. When an advertisement call is made to the marketing system 102, the marketing system 102 can receive the publisher specific custom visitor ID, a publisher ID, and a unique device ID for the first client device. The combination of the publisher specific custom visitor ID and a publisher ID can identify the given user and the unique device ID can identify the first client device. The user profile manager 212 can associate each of the publisher specific custom visitor ID, the publisher ID, and the unique device ID for the first client device with a user profile.

When the user logs into the publisher platform using a second client device (e.g., a tablet), the publisher specific custom visitor ID and the publisher ID will be the same. The unique device ID, however, will be different as the device is different. The user profile manager 212 can associate the new unique device ID for the second client device with the user profile. The ability to link multiple client device IDs to the user profile can allow the marketing system 102 to cap the amount of marketing content provided to the user across multiple client devices.

In addition to associating multiple client device IDs to the user profile, the user profile manager 212 can associate multiple custom visitor IDs and publisher IDs with the user profile. For example, upon the user logging into a platform of a second content publisher using the first client device, the marketing system 102 can receive a second publisher specific custom visitor ID, a second publisher ID, and the unique device ID for the first client device. Based on the unique device ID being associated with the user profile, the user profile manager 212 can associate the second publisher specific custom visitor ID and the second publisher ID with the use profile. The ability to link multiple publisher specific custom visitor IDs and publisher IDs to the user profile can allow the marketing system 102 to cap the amount of marketing content provided to the user across multiple content providers.

Thus, the user profile can comprise a merged account that includes one or more identifiers associated with a specific client device and one or more user identifiers for various user accounts that have been used when operating the client device. Additionally, while the user profile can include user identifiers for each user that has used a particular client device, one or more embodiments of the user profile can include only those user identifiers associated with a specific user 108. Identifying a specific user 108 may include receiving an indication or confirmation from a user 108 that a particular identifier corresponds to the user 108.

In addition to identifying a specific user 108 based a login provided to the marketing system 102, the user profile manager 212 may further include features and functionality for identifying a specific user 108 based on one or more actions performed by the user 108 using the client device. For example, the user profile manager 212 can identify a feature or characteristic of streaming digital media and determine, based on a comparison of the feature or characteristic with user profile information, that a specific user 108 associated with a user profile is using the client device. In this way, even in cases where the user 108 fails to provide a registered login that is part of a user account (e.g., a merged account), the marketing system 102 can reliably identify the user 108 using the client device as a user 108 associated with a particular user profile and manage a quantity of marketing content provided to the user 108 in accordance with other embodiments described herein.

Furthermore, the marketing system 102 can identify a user 108 with or without receiving a custom visitor ID. In particular, as described above, a user profile can include an identification or information associated with one or more client devices 106a-b that are commonly used by a particular user 108. In the case that the marketing system 102 detects an unidentified user logging onto a website from one of the client devices 106a-b, the marketing system 102 can monitor and analyze actions performed on the client device and/or features of digital media presented to the unidentified user via the client device. In particular, upon identifying a login using a client device that is associated with one or more user profiles, the marketing system can compare actions performed on the client device and/or features of digital media provided to the client device to verify the identity of the unidentified user using the client device. As such, where multiple users use a common client device, the marketing system can verify the identity of the user 108 even without receiving a login for the user 108 included within the user profile.

As mentioned above, the profile manager 202 can further include a content publisher profile manager 214 that manages one or more publisher profiles for publishers associated with various content servers 204a-c. For example, the content publisher profile manager 214 can maintain a content publisher profile for a content publisher that has registered with the marketing system 102. Similar to registering user profiles, the content publisher profile manager 214 can maintain a content publisher profile or publisher account associated with a content publisher that includes various types of information about the content publisher. In one or more embodiments, the content publisher can provide information about the content publisher to the marketing system 102 upon registering the content publisher with the marketing system 102.

Further, in one or more embodiments, the content publisher profile can include various types of information about a content publisher. For instance, the content publisher profile can include information about one or more content servers corresponding to a specific publisher. For example, in accordance with embodiments herein, a first publisher profile may include information about a first content server 104a associated with a first publisher. Also, a second publisher profile may include information about a second content server 104b associated with a second publisher. Further, a third publisher profile may include information about a third content server 104c associated with a third publisher. In one or more embodiments, a content publisher profile can include information about multiple content servers associated with the same publisher.

Further, the content publisher profile manager 214 can manage information associated with marketing content that a content publisher provides to various users. In particular, the content publisher profile manager 214 may track a quantity of marketing content for one or more marketing campaigns that a content publisher has provided to one or more users. For example, the content publisher profile manager 214 can monitor how many advertisements that a content publisher provides to multiple users for a specific marketing campaign in conjunction with digital media provided to the user. Additionally, the content publisher profile manager 214 can update the content publisher's profile to reflect the quantity and monetary values associated with providing the marketing content to different users.

As mentioned above, the marketing system 102 can further include a campaign manager 204 that manages information associated with one or more marketing campaigns. In particular, a merchant, marketer, organization, or other entity may launch a marketing campaign that promotes awareness for a particular product or service. For example, a marketer may launch a marketing campaign to promote a new product with an approaching public release. Further, as described above, a marketing campaign can include one or more advertisements including multiple advertisements of a single type (e.g., videos) as well as one or more advertisements of different types (e.g., videos, banners, pop-ups, overlays, audio clips) that are related to the new product or service.

In realizing features and functionality of the marketing system 102, the campaign manager 204 can launch a marketing campaign by identifying or receiving marketing content to provide to content servers 104a-c. Additionally, as part of launching a marketing campaign, the campaign manager 204 can identify a budget associated with the marketing campaign and one or more values associated with different advertisements. For example, a marketing campaign can specify a maximum allowable quantity of marketing content that a user 108 is permitted to receive as well as a value or quantity attributable to each advertisement that makes up a marketing campaign.

Additionally, in one or more embodiments, the marketing campaign can include one or more campaign traits that are applicable to the marketing campaign. In particular, campaign traits can include one or more rules pertaining to different users, publishers, devices, and/or advertisements that may be applied in managing a quantity of marketing content provided to a user 108. For example, launching a marketing campaign may include creating a trait in a content publisher's account and associating one or more user segments with the trait. As marketing content is provided to users, the marketing system 102 may assign users to the one or more user segments indicating users that the marketing system 102 will prevent from receiving additional marketing content for the marketing campaign.

As mentioned above, the campaign manager 204 can include an ad selector 216. In particular, the ad selector 216 can select advertisements to provide to one or more client devices 106a-b. For example, the ad selector 216 can select advertisements based on user profile information and/or publisher profile information. To illustrate, the ad selector 216 can select an advertisement for a marketing campaign that is targeted to the user 108 based on personal information from the user profile associated with the user 108. Accordingly, the ad selector 216 can select between multiple advertisements to provide one or more advertisements that are targeted to the user 108.

Additionally, in one or more embodiments, the ad selector 216 can select one or more advertisements to provide to the user 108 based on the digital media and/or publisher associated with the digital media provided to the user 108. For example, where a marketing campaign includes a first video with a celebrity spokesman and a second video with an athlete spokesman, the first video may be better suited for delivery in conjunction with an entertainment website while the second video may be better suited for delivery in conjunction with a sports website. In this example, the ad selector 216 can select the first video to provide to a content server that hosts an entertainment website and select the second video to provide to a content server that hosts a sports website.

The ad selector 216 can select one or more advertisements in such a way as to promote diversity in marketing content provided to the user 108. For example, the ad selector 216 may select between streaming a first video and a second video to a client device based on a number of times each video has been provided to the user 108. As such, in an example where a first video is more precisely targeted to the user 108 based on information from the user's profile, the ad selector 214 may nonetheless select the second video at least once for every two times that the client device presents the first video to the user 108.

In one or more embodiments, the campaign manger 204 can optionally include an ad server 218. In particular, the ad server 218 can provide the marketing content for a marketing campaign to the content servers 104a-c. For example, the ad server 218 can provide one or more video advertisements for a marketing campaign to content servers 104a-c for delivery to one or more client devices 106a-b. In one or more embodiments, the client devices 106a-b and/or content servers 104a-c can request marketing content from the ad server 218 for a particular user and the ad server 218 can provide the selected advertisement to the content servers 104a-c for delivery to a user 108.

Thus, the marketing system 102 can work in conjunction with the content provider to provide advertisements with the streaming content from the content provider. Specifically, the marketing system 102 can provide targeted advertising to the client devices 106a-106c in conjunction with content associated with the content provider 104a-c. For example, while the content provider 104a-c provides streaming content to one or more of the client devices 106a-106c, the marketing system 102 can provide targeted advertisements to the client devices 106a-106c based on, and in association with, the streaming content. In additional or alternative embodiments, the marketing system 102 can use information about the users, the concurrent streaming account, and/or the client devices 106a-106c to provide the targeted advertising.

In one or more embodiments, the marketing system 102 seamlessly inserts advertisements into live, linear or video-on-demand (VOD) content. In particular, the marketing system 102 can create engaging, buffer-free ads and content experience for viewers. The marketing system 102 can provide the ads to the content provider 104a-c, which can provide the ads together with the streaming content to the client devices 106a-106c in a single data stream. Alternatively, the marketing system 102 can provide the advertisements directly to a player on the client devices 106a-106c. The player can integrate the advertisements with the streaming content received from the content provider 104a-c.

The marketing system 102 can provide buffer-free ads by avoiding a dual-player situation in which one player provides the streaming content and another player provides the advertisement. In particular, a single player on a client device 106a-106c can play a stream of content from the content provider 104a-c that includes advertisements stitched into the stream at appropriate places. Alternatively, the marketing system 102 can provide the advertisements directly to a player at the client devices 106a-106c, the player can then leverage broadcast ad break cues (e.g., SCTE 35), markers injected in real-time via a “big red button” interface, or ad timelines stored in the content provider's 104a-c content management system. In any event, upon detecting the need for an advertisement, the player can seamlessly insert an advertisement provided by the marketing system 102 into the streaming content from the content provider 104a-c.

In addition to selecting marketing content and providing marketing content to the content servers 104a-c, the campaign manager 204 may further identify or otherwise determine various budgets for the marketing campaign. For example, the campaign manager 204 may receive or determine an overall budget for launching the marketing campaign to a community of users. The budget may depend on costs associated with providing marketing content to various users as well as the number of users that the campaign manager 204 elects to target. For example, where the campaign manager 204 wants to stream a video advertisement 10,000 times and publishers charge ten cents per view, the campaign manager 204 may facilitate delivering the video advertisement 100,000 times to various users.

In one or more embodiments, the campaign manager 204 may further determine a budget for individual users in an effort to broaden the number of viewers that view a specific advertisement as well as avoiding burnout or annoyance for providing the same advertisement to the same users over and over. In particular, the campaign manager 204 can determine a maximum allowable quantity of marketing content for the marketing campaign that users of the marketing system 102 can receive within a period of time. For example, the campaign manager 204 can determine that a user 108 can receive no more than five views of a particular advertisement within a twenty-four hour period.

In determining a maximum allowable quantity of marketing content for a user 108, the campaign manager 204 can consider the user profile for the user 108 and determine a maximum allowable quantity of marketing content for the user 108 that varies from the maximum allowable quantity of marketing content for other users. For example, where a user's profile indicates an interest or hobby that is related to a product or service of a marketing campaign, the campaign manager 204 may associate a larger maximum quantity of marketing content with the user 108 than another user whose indicated interest and hobbies are less related to the marketing campaign. More specifically, the marketing system 102 may associate a user having relevant interests or hobbies with a different user segment than another user having less relevant interests or hobbies.

In addition to determining budgets for individual users, the campaign manager 204 can determine budgets or costs associated with individual advertisements that make up a marketing campaign. For example, where a marketing campaign includes multiple advertisements, each advertisement may have a different cost associated with providing the advertisement to a user 108. For instance, a video advertisement may cost ten cents to provide to a user 108 while a banner or overlay only costs five cents to provide to the user 108. These different values may be considered when tracking the total quantity of marketing content provided to a user 108, as described in greater detail below.

While the value or costs associated with individual advertisements may vary, one or more publishers may also have different costs and values associated with delivering marketing content than other publishers. For example, a first publisher may charge ten cents to stream a video advertisement to a user 108 while a second publisher only charges five cents to stream the same video advertisement to the user 108. Similar to different costs associated with different advertisements, these values associated with different publishers may be considered when tracking the total quantity of marketing content provided to a user 108.

As mentioned above, the marketing system 102 can further include a tracking engine 206 that facilitates monitoring a quantity of marketing content provided to a user 108. In particular, the tracking engine 206 can identify receipt of one or more advertisements by a user 108. Additionally, each time the user 108 receives an advertisement of the marketing campaign, the tracking engine 206 can update a total quantity of marketing content for the marketing campaign that the user 108 has received. Further, the tracking engine 206 can determine whether the user 108 has received a maximum allowable quantity of marketing content and facilitate preventing the user 108 from receiving any additional marketing content for the marketing campaign for a period of time.

In one or more embodiments, the tracking engine 206 may include a call counter 220 that receives and processes a tracking call each time the user 108 receives an advertisement for the marketing campaign. In particular, the call counter 220 may receive a tracking call from a client device each time a content server provides an advertisement to the user 108 via the client device. Additionally, each tracking call may include information embedded within the tracking call that provides an indication of the user 108, client device, publisher, and quantity associated with the advertisement received by the user 108. For example, a tracking call may be invoked by one or more URLs embedded within the marketing content. The tracking call may indicate a quantity (e.g., a value, cost, or other metric) associated with the advertisement provided to the user 108.

In one or more embodiments, the call counter 220 can receive multiple tracking calls for each advertisement provided to the user 108. For example, the marketing system 102 may receive a first tracking call with information for tracking a quantity of marketing content for user's account. Additionally, the marketing system 102 can receive a second tracking call with information to include within the content publisher's account.

In addition to the call counter 220 that receives and tracks a number of tracking elements (e.g., tracking URLs) provided to the marketing system 102, the tracking engine 206 may further include a quantity calculator 222 that calculates a quantity of marketing content provided to the user 108 and determines whether the user 108 has received a maximum allowable quantity of marketing content for the marketing campaign. In particular, the quantity calculator 222 can calculate a quantity of marketing content received by the user 108 based on a count of tracking elements and a maximum allowable quantity of marketing content that a user 108 is allowed to receive for the marketing campaign under various circumstances. In one or more embodiments, the quantity calculator 222 can calculate a quantity of marketing content based on a total number of advertisements that the user 108 has received. Additionally, the quantity calculator 222 can calculate a quantity of marketing content based on a combination of advertisements and values associated with the advertisements provided to the user 108.

As mentioned above, the marketing system 102 can further include a communication manager 208 that manages communications between the marketing system 102 and one or more client devices 106a-b. For example, the communication manager 208 can receive information from a client device for use in creating a user profile and/or updating an already existing user profile for the user 108. Additionally, the communication manager 208 can receive one or more tracking calls from a client device each time a user 108 receives an advertisement from a marketing campaign. For example, the communication manager 108 can interface with a client-side plugin installed on the client devices 106a-b each time the user 108 receives marketing content from one or more content servers 104a-c.

Additionally, the communication manager 208 can manage communications between the marketing system 102 and one or more content servers 104a-c over the network 110. For example, the communication manager 208 can receive an indication of a user 108 from a content server 104a-c each time a user 108 logs onto a content server 104a-c. For example, when the user 108 logs onto a content server, the content server may provide a content publisher specific identifier for the user 108 via the communication manager 208. Additionally, in one or more embodiments, the communication manager 208 may receive an identification of the user 108, client device, advertisement provided to the user 108 and/or other information associated with delivering marketing content to the user 108 over the network 110.

Furthermore, as mentioned above, and as illustrated in FIG. 2, the marketing system 102 can include a data storage 210 including user data 224, publisher data 226, and campaign data 228. In particular, user data 224 can include any information associated with a user. For example, user data 224 can include user profile information such as, for example, personal information, login credentials, account information, device information, and other information associated with a user 108 of the marketing system 102. Additionally, the content publisher data 226 can include publisher profile information including, for example, information about one or more content servers associated with a respective publisher and/or traits associated with various publishers. Furthermore, the campaign data 228 can include information about a marketing campaign including, for example, campaign budgets, user budgets, specific advertisement values, traits, user segments, and/or other information associated with a particular marketing campaign.

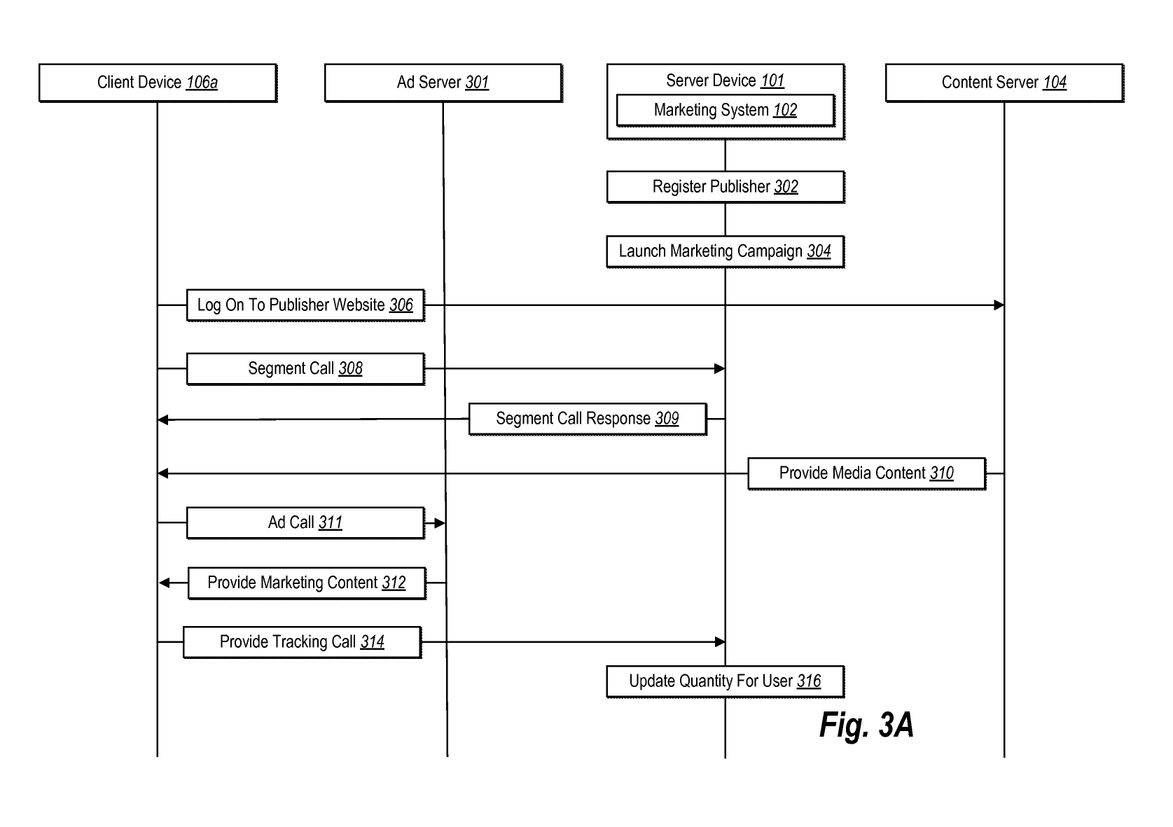

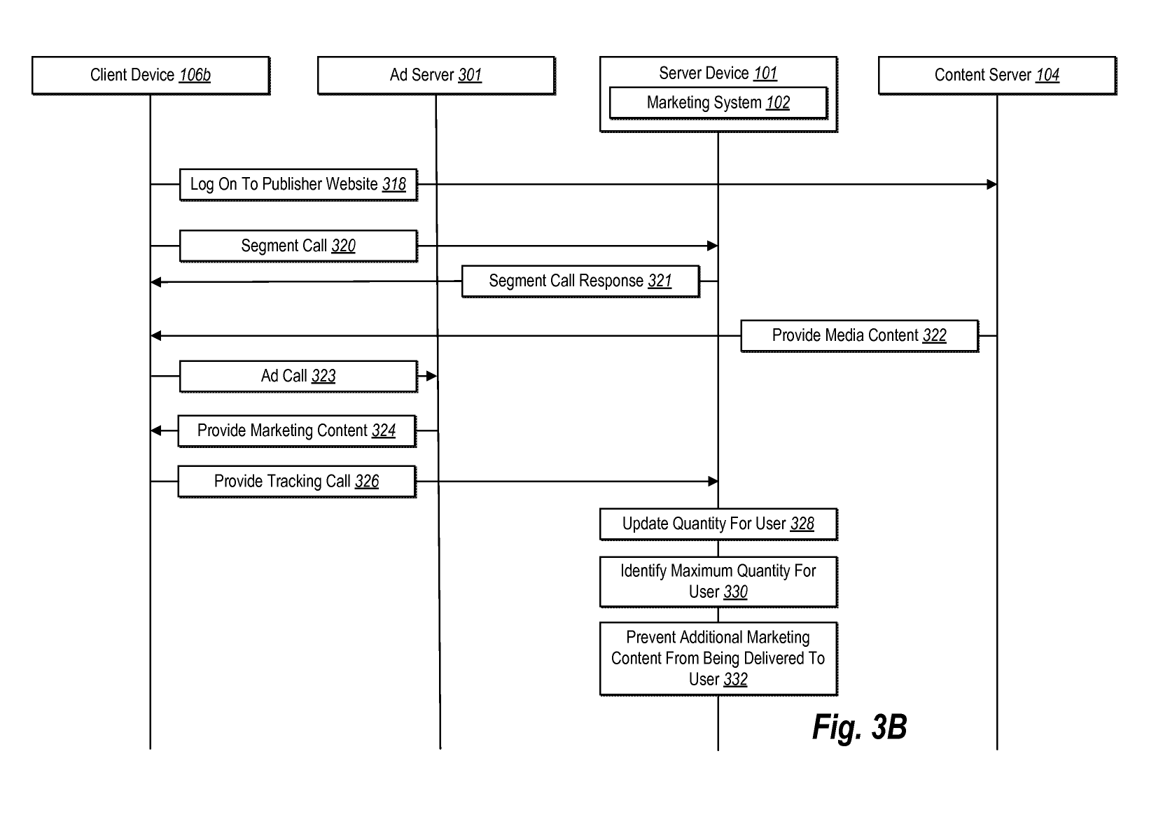

FIGS. 3A-3B illustrate a flow diagram of interactions between a first client device 106a, a second client device 106b, a server device 101, ad server 301, and a content server 104 associated with a content publisher. In particular, FIGS. 3A-3B illustrate one example embodiment for limiting content frequency for a marketing campaign provided to a user 108 across multiple client devices 106a-b.

As illustrated in FIG. 3A, the marketing system 102 can register 302 a provider with the marketing system 102. In particular, the marketing system 102 can receive information about a content publisher for creating a content publisher profile on the marketing system 102 that includes information about the content publisher. For example, the content publisher profile can include information about a content server 104 owned by, operated, or otherwise associated with the content publisher. Additionally, the content publisher profile can include information about digital media provided by the content publisher and costs associated with providing marketing content in conjunction with digital media to one or more client devices 106a-b. For example, the content publisher profile may include categories or topics of interests that are relevant to the digital media that the marketing system 102 may consider in selecting advertisements to deliver via a particular content server 104. Moreover, in addition to identifying information about the content publisher and/or content server 104, registering 304 can involve assigning a content publisher-specific identifier (hereinafter “publisher ID”) that the marketing system 102 can use to identify the content publisher and/or content server 104 associated with the content publisher.

After registering the content publisher with the marketing system 102, the marketing system 102 can launch 304 a marketing campaign. In particular, the marketing system 102 can launch a marketing campaign for a merchant to promote awareness for a particular product or service. As described above, a marketing campaign can include a collection of one or more advertisements to be presented to a user 108 via the first client device 106a or the second client device 106b. In one or more embodiments, launching the marketing campaign can involve selecting and delivering advertisements to the content server 104 based on the digital media that the content server 104 delivers to various users. For example, if the content server 104 hosts a sports website, the marketing system 102 may select a video advertisement for a product that features an athlete's endorsement.

In addition to selecting and delivering advertisements, launching the marketing campaign can include determining a per-user advertisement budget and associating values (e.g., cost values, quantity values) with each advertisement of the marketing campaign. As an example, a marketing campaign may have a per-user budget of one dollar per user with a first video advertisement (hereinafter “first ad”) that costs 20 cents per view and a second video advertisement (hereinafter “second ad”) that costs 10 cents per view. Other embodiments may include fewer or additional advertisements associated with similar or different costs.

In addition to identifying the costs of individual advertisements, launching the marketing campaign may further involve determining a content quantity to associate with various advertisements. For example, where the first ad costs 20 cents per view and the second ad costs 10 cents per view, the marketing system 102 may determine that a highest common factor between the first ad and the second ad is 10 cents. Accordingly, the marketing system 102 can associate the first ad with a tracking element strength of 2 and the second ad with a tracking element strength of 1. Additionally, because each increment of tracking element corresponds to ten cents, and the total budget per user is one dollar per day, the frequency cap for the marketing campaign may equal 10 tracking elements per day per user. The marketing system 102 may user these tracking elements (e.g., embedded within tracking calls) to track a quantity of marketing content received by a user 108.

Launching a marketing campaign can further involve creating a campaign trait for the content publisher's account as well as one or more user segments associated with the campaign trait. In particular, the campaign trait and a user segment can identify a maximum allowable quantity of marketing content that any user associated with a specific user segment is permitted to receive within a predefined period of time. For example, where the user 108 is associated with a user segment that is associated with a campaign trait of 10 (e.g., 10 tracking elements, 10 tracking URLs, or an accumulation of 10 tracking calls), the marketing system 102 may apply a rule to the user 108 that caps a total quantity of marketing content for the user 108 to receive within a specific period of time to 10 calls worth of content.

Moreover, in one or more embodiments, the marketing system 102 may create the campaign trait and store the trait in a folder located on a client device and/or on the server device 101 (e.g., accessible from the client device). Additionally, the marketing system 102 may create one or more user segments associated with the campaign trait and store the user segment(s) on the client device and/or on the server device 101. In accordance with the campaign trait, the marketing system 102 can define rules associated with each segment (e.g., 10 tracking calls for a user segment). The marketing system 102 can store the rules on the client device and/or marketing system 102 and otherwise ensure that the segment or identifier corresponding to the segment is returned to a player or plug-in on the client device when the user 108 falls under the user segment.

As mentioned above, a marketing campaign may include multiple user segments. For example, a marketing campaign can include a first user segment that applies to users generally as well as a second user segment that applies to users having relevant interest or hobbies that relate to the product or service promoted by the marketing campaign. As such, the campaign trait can specify a first maximum quantity of marketing content to be delivered to users assigned to the first segment and a second maximum quantity of marketing content to be delivered to users assigned to the second segment. Because the second segment of users likely have a greater interest in the products or services of the marketing campaign, the campaign trait may allow a higher quantity of marketing content to be delivered to users belonging to the second user segment than those users that belong to the first user segment. Other embodiments may include fewer or additional user segments for each campaign trait.

In assigning a user 108 to a user segment, the marketing system 102 can consider profile information (e.g., demographic information, personal information) to determine whether the user 108 belongs to a particular user segment. For example, if a user 108 indicates a hobby in sports or athletics, the marketing system 102 may associate the user 108 to a user segment that receives more marketing content for sporting goods. Alternatively, if the user 108 has no interest in sports or athletics, the marketing system 102 may associate the user 108 to a different user segment that receives fewer advertisements for sporting goods. Further, as illustrated in FIG. 3A, associating the user 108 may be performed as part of launching 306 the marketing campaign. Alternatively, the marketing system 102 may associate the user 108 with a user segment upon a client device or content server (e.g., a plugin on the client device) requesting delivery of marketing content from an ad server and/or the user 108 logging on to the content server 104.

As illustrated in FIG. 3A, a user 108 can log on 306 to a content publisher's website using the first client device 106a. In particular, the first client device 106a can establish a connection with the content server 104 to receive digital media from the content server 104. Once the user 108 logs on to the website, the content server 104 can assign a content publisher-specific custom visitor ID (hereinafter “custom visitor ID”) that identifies the user 108 based on a login for the user 108 on the content publishers website, a third-party website, or a login for the marketing system 102. Additionally, the content server 104 can provide the custom visitor ID to the marketing system 102. Thus, the marketing system 102 can identify a user 108 based on a content publisher ID and a custom visitor ID. Additionally, in response to establishing a connection with the first client device 106a, the content server 104 can pass a unique identifier for the first client device (hereinafter “first device ID”) to the marketing system 102 for use in identifying the first client device 106a.

Alternatively, the marketing system 102 can obtain the unique identifier for the first client device directly from the first client device 106a via a tracking pixel or other tracking call associated with an advertisement. More specifically, the first client device 106a can include a client application (e.g., a player) that includes a plug-in. The plug-in can obtain information about the client device 106a and the user and send this information to the marketing system 102. To illustrate, a video player playing content (e.g., streaming video) at a client device 106a can include a plugin (e.g., ADOBE AUDITUDE) that obtains the information about the client device 106a, the user, and/or the content and sends the information to the marketing system 102. In particular, the plugin or another component of the client device 106a can pass a device/unique identifier and a common concurrent streaming account user identifier used to access content from one or more content providers to the marketing system 102.

Additionally, when the first client device 106a logs on to the content server 104, the first client device 106a (e.g., a plugin on the first client device 106a) can make 308 a segment call to the marketing system 102 and request one or more user segments to which the user 108 belongs. In response, the client device 106a can receive an indication of any user segments for which the user 108 has been capped and one or more marketing campaigns for which the user 108 has reached a maximum allowable quantity of marketing content and for which the marketing system 102 will prevent the user 108 from receiving additional marketing content. For instance, upon making the segment call to the server device 101, the server device 101 may provide a response that includes user segment information associated with the user 108. As an example, in response to receiving a call for user segment information, the server device 101 may provide a response similar to the response below:

{

“stuff”: [{

“cn”: “aud”,

“cv”: “segs=31414_cross_device_spend_cap_seg,
31415_cross_device_spend_cap_seg”,

“ttl”: 30,
“dmn”: “auditude.com”

}],
“uuid”: “29826631350318718281347548143759095111”,
“dcs_region”: 3

}

where uuid refers to a machine identifier and segs refer to user segments. For example, 31414_cross_device_spend_cap_seg under “segs” may refer to a 31414 marketing campaign that has been capped for the user 108 and for which the user 108 should not be served any additional advertisements or marketing content for the corresponding marketing campaign.

In one or more embodiments, in response to making the segment call, the server device 101 may provide 309 a segment call response indicating one or more user segments to which the user 108 of the first client device 106a belongs. For example, as mentioned above, the server device 101 may assign or otherwise associate the user 108 with one or more user segments as the user 108 receives a maximum allowable quantity of marketing content for a particular marketing campaign corresponding to the user segment. Accordingly, in response to receiving the segment request, the server device 101 may provide a segment request response indicating any user segments to which the user 108 has been assigned.

In addition, the content server 104 may provide 310 media content to a user 108 via the first client device 106a. For example, the content server 104 may provide a website to the user 108 via a display on the first client device 106a. In another example, the content server 104 may stream digital content (e.g., a video) to the user 108 in conjunction with providing a website that the user 108 has logged into. In one or more embodiments, the content server 104 may provide the media content to the user 108 subsequent to the first client device 106a sending the segment request to the server device 101. Additionally, the content server 104 may continuously provide media content to the user 108 in conjunction with other steps described in conjunction with FIG. 3A and 3B. Moreover, in one or more embodiments, providing digital media to the first client device 106a may trigger a request from the first client device 106a and/or content server 104 for one or more advertisements to be provided to the user 108 in conjunction with digital media.

The first client device 106a can further make 311 an ad call to an ad server 301. In particular, the first client device 106a may provide information to the ad server 301 in conjunction with requesting an advertisement (e.g., an overlay or a video advertisement). In one or more embodiments, making the ad call may include providing user segment information to the server device 101 previously received in the user segment response as well as information about the user 108 and/or the first client device 106a. For instance, in the above example, making an ad call may include providing the segments and uuid to an ad server. In particular, the marketing system 102 may provide 310 an ad call to an ad server 301 that includes segment information associated with the user 108 and corresponding to the segment information for the user 108. As an example, in accordance with the above embodiment(s), the segments and uuid may be sent to an ad server in a similar format as shown below:
aud_aam_segs=31414_cross_device_spend_cap_seg;
aud_aam_segs=31415_cross_device_spend_cap_seg;
aud_aam_uuid=29826631350318718281347548143759095111;
aud_aam_dpuuid=userID;
   In response, the ad server may take these parameters and not serve or otherwise prevent serving advertisements corresponding to the 31414 and 31415 marketing campaigns. Instead, as will be described in further detail below, the ad server will serve advertisements from other marketing campaigns.

Further, as illustrated in FIG. 3A, the ad server 301 can provide 312 marketing content to the first client device 106a. In particular, the ad server 301 can provide the marketing content in conjunction with digital media provided to the first client device 106a from the content server 104. Additionally, as referred to above, the ad server 301 may provide marketing content for a marketing campaign for which the ad server 301 and/or marketing system 102 has not received a corresponding user segment indicating that the user 108 has received a maximum allowable quantity of marketing content. In one or more embodiments, the ad server 301 delivers marketing content received from the server device 101. Alternatively, the ad server 301 may be implemented on the server device 101. While not shown in FIG. 3A, marketing content may also be received from the client device 106a itself (e.g., using a plugin previously installed on the client device 106a) or, alternatively, from the content server 104.

In response to receiving the marketing content, the first client device 106a can provide 314 a tracking call to the marketing system 102 to indicate receipt of the marketing content to the user 108. In particular, a plugin on the first client device 106a may interface with the marketing system 102 and provide a tracking call to the marketing system 102 that indicates receipt of the marketing content. The tracking call may include information associated with the marketing content received by the user 108 as well as identifying information of the user 108 and/or publisher. For example, the tracking call may be invoked in response to an embedded tracking element (e.g., a tracking URL or a tracking pixel). Receipt of a tracking call can indicate or include a custom visitor ID, a content publisher ID, a first device ID, an advertisement identifier and a quantity that represents a portion of the budget for the marketing campaign for the advertisement viewed on the first client device 106a. Additionally, the first client device 106a can provide another tracking call including one or more tracking elements including information to include within the content publisher's account.

As illustrated in FIG. 3A, the marketing system 102 can update 316 a quantity of marketing content that the user 108 has received. For example, in response to receiving the tracking call from the first client device 106a, the marketing system 102 can add to a running total of calls, traits, or other indicator of marketing content quantity that the marketing system 102 maintains for the user 108.

Additionally, as shown in FIG. 3B, the user 108 can log on 318 to a content publisher's website using the second client device 106b. Logging on to the content publisher's website using the second client device 106b can involve similar features as described above in connection with logging on to the content publisher's website using the first client device 106a. Additionally, similar to FIG. 3A, the second client device 106b can make 320 a call to the server device 101. Making a call using the second client device 106b can be similar to making a call described above in connection with FIG. 3A where the call includes a device identifier unique to the second client device 106b rather than the first client device 106a.

Further, as shown in FIG. 3B, in response to receiving the segment call, the server device 101 may provide a segment call response 321 to the second client device 106b similar to the segment call response described above in connection with FIG. 3A. For example, the server device 101 may provide a segment request response indicating any user segments to which the user 108 has been assigned. Furthermore, similar to FIG. 3A, the content server 104 may provide 322 media content to the user 108 via the second client device 106b. For example, the content server 104 may stream a video to the second client device 108b.

Additionally, as shown in FIG. 3B, the second client device 106b can make 323 an ad call to an ad server 301. Making an ad call can include similar steps as described above in connection with FIG. 3A. Additionally, while not explicitly illustrated in FIG. 3B, in some embodiments, the ad call can also be made by the first client device 106a instead of the second client device 106b in a similar manner as if the second client device 106b had made the ad call. Furthermore, in both cases of the first client device 106a and second client device 106b making the ad call, the client device making the ad call may provide the ad call to the server device 101 after making the segment call described previously in order to obtain updated segment details to provide to the server device 101 in conjunction with making the ad call. Additionally, similar to making the ad call described above in connection with FIG. 3A, the second client device 106b can provide segment information (e.g., updated segment information) and a device identifier corresponding to the second client device 106b to the ad server 301 for use in determining which marketing content from which marketing campaign to provide to the user 108.

Additionally, the content server 104 can provide the custom visitor ID to the marketing system 102. Further, in one or more embodiments, the content server 104 can pass a unique identifier for the second client device (hereinafter “second device ID”) and provide the second device ID to the marketing system 102 for identifying the second client device 106b. Alternatively, the marketing system 102 can obtain the unique identifier for the second client device directly from the second client device 106b via a tracking pixel or other tracking call associated with an advertisement.

As illustrated in FIG. 3B, the ad server 301 can provide 324 marketing content to the second client device 106b in conjunction with digital media provided to the second client device 106b. Additionally, in response to receiving the marketing content, the second client device 106b can make 326 a tracking call to the to indicate receipt of the content to the user 108. Similar to the tracking call provided from the first client device 106b, the tracking call may include information associated with the marketing content received by the user 108 as well as identifying information of the user 108 and/or publisher. For example, as part of rendering the marketing content, in response to a click on the marketing content, the second client device 106b can make the tracking call. Thus, the marketing content may include an embedded tracking element (e.g., a tracking URL) that includes a custom visitor ID, a content publisher ID, a first device ID, an advertisement identifier and a quantity that represents a portion of the budget for the marketing campaign for the advertisement viewed on the second client device 106b. In response to receiving the tracking call, the marketing system 102 can update 328 the total quantity that the user 108 has received for the marketing campaign.

As illustrated in FIG. 3B, the marketing system 102 can identify 330 that the user 108 has received a maximum allowable quantity of marketing content for the marketing campaign. For example, when the marketing system 102 identifies a tracking element count that equals a user segment associated with a campaign trait for the marketing campaign, the marketing system 102 may identify that the user 108 has received the maximum allowable quantity of marketing content for the campaign. In one or more embodiments, identifying that the user 108 has received the maximum allowable quantity involves receiving an indication of the user segment from a client device having a plugin that interfaces with the marketing system 102 on the server device 101.

In response to determining that the user 108 has received the maximum allowable quantity of marketing content for the campaign, the marketing system 102 can prevent 332 the user from receiving additional marketing content. For example, the marketing system 102 can facilitate selection of different advertisements to deliver to the user 108. In one or more embodiments, the marketing system 102 can simply block delivery of additional advertisements to the user 108 associated with the marketing campaign. The marketing system 102 may further instruct the ad server 301 and/or content server 104 to cease delivery of additional marketing content to the user 108.

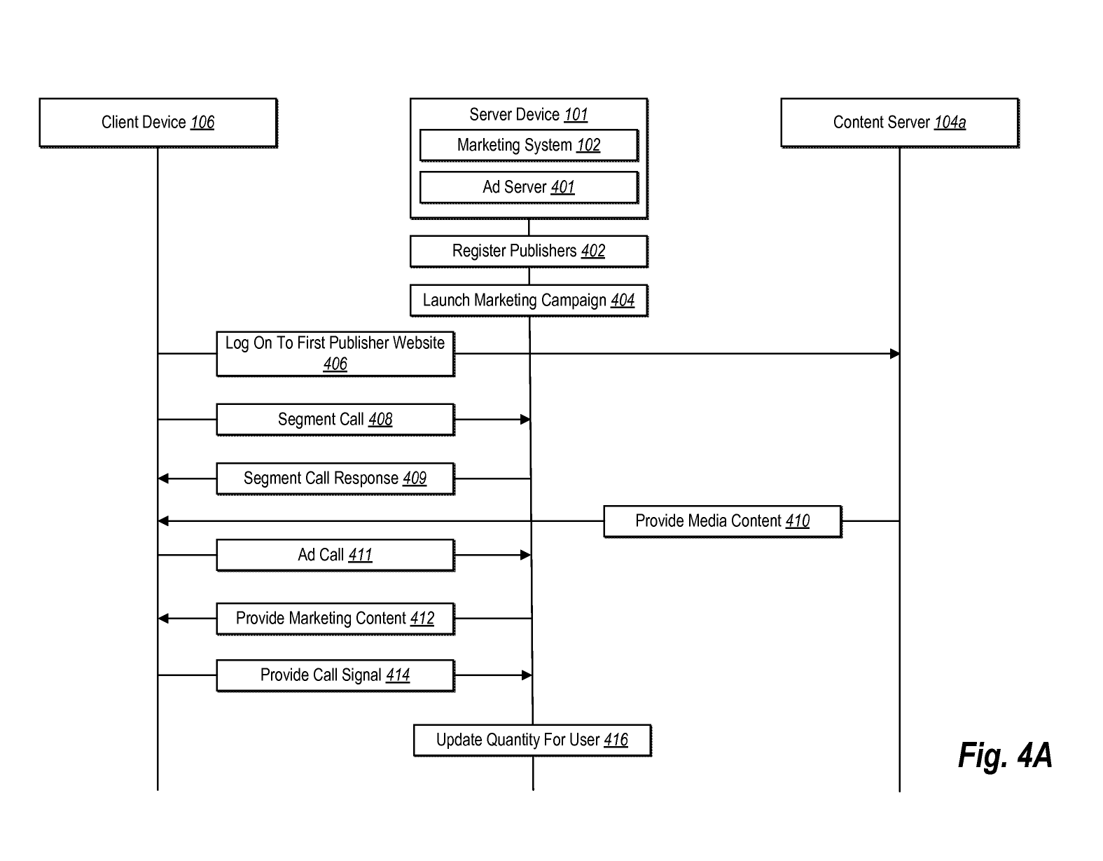

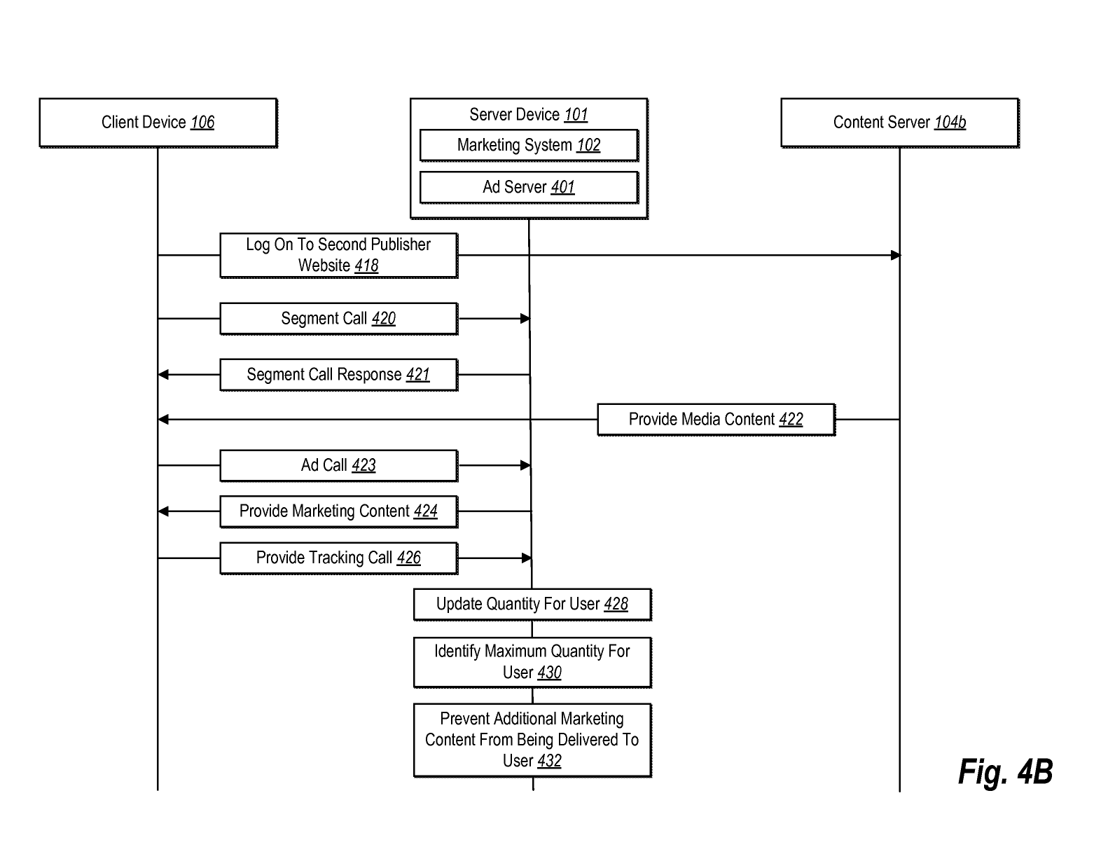

FIGS. 4A-4B illustrate a flow diagram of interactions between a client device 106, a server device 101 that includes or implements the marketing system 102, a first content server 104a, and a second content server 104b. The first content server 104a may correspond to a first publisher and the second content server 104b may correspond to a second publisher. In particular, FIGS. 4A-4B illustrate one example embodiment for limiting content frequency for a marketing campaign provided to a user 108 from multiple publishers. Further, while FIGS. 4A-4B illustrate one embodiment in which marketing content is provided to a user 108 via a single client device 106, features and functionality described in connection with FIGS. 4A-4B can combine with other features and functions described above in connection with other embodiments. For example, as shown in FIGS. 4A-4B, the server device 101 may include a marketing system 102 and an ad server 401 that may include similar features and functionality as other ad servers described herein. Alternatively, the marketing system 102 and ad server 401 be implemented on separate devices.

As illustrated in FIG. 4A, the marketing system 102 can register 402 each of the first publisher and the second publisher with the marketing system 102. Registering the publishers can include similar steps and features as described above in connection with FIGS. 3A-3B. Additionally, the marketing system 102 can assign a unique publisher ID for each of the first publisher and the second publisher that the marketing system 102 can use to identify the first or second publisher. Further, similar to the merged or combined account for individual users as described above, the marketing system 102 may also create a combined publisher account for each of the content publishers that have registered with the marketing system 102.

Additionally, as illustrated in FIG. 4A, the marketing system 102 can launch 404 a marketing campaign using similar steps and features as described above in connection with launching a marketing campaign as described above in connection with FIG. 3A. Further, launching the marketing campaign may include identifying marketing content to be delivered to the client device 106 in conjunction with media content from the first content server 104a and media content from the second content server 104b, respectively. For example, the marketing system 102 can identify different marketing content for the first content server 104a and the second content server 104b based on the digital media associated with the different publishers. Alternatively, the marketing system 102 can identify the same or similar marketing content to provide to the user 108 in conjunction with each of the first content server 104a and the second content server 104b. Additionally, the marketing system 102 can assign a unique advertisement identifier (hereinafter “ad ID”) for each advertisement within the marketing campaign. For example, the marketing campaign may include a first advertisement assigned a first ad ID and a second advertisement assigned a second ad ID. The ad IDs may be different for the same advertisement for different advertisements within the same campaign.

Additionally, launching a marketing campaign may include creating a campaign trait for each publisher that has registered with the marketing system 102 that identifies a maximum allowable quantity of marketing content that one or more users may receive for a particular marketing campaign. For example, the marketing system 102 can assign the first publisher a first campaign trait and the second publisher a second campaign trait. The campaign traits for each publisher may be similar to the campaign traits described above in connection with FIGS. 3A-3B. Additionally, in one or more embodiments, the marketing system 102 can create a trait for a combined account for one or more publishers.

As illustrated in FIG. 4A, the user 108 can log on 406 to the first publisher's website via the first content server 104a. For example, the user 108 may log on to the first publisher's website using a login for the marketing system 102 or, alternatively, a login associated with the content publisher's website or a third-party website (e.g., FACEBOOK or GOOGLE). In response, the content server 104a can provide a content publisher-specific custom visitor ID for the user 108.

Upon logging on to the first content server 104a, the client device 106 may make 408 a segment call and request one or more user segments to which the user 108 belongs. In response, the server device 101 can identify one or more user segments to which the user 108 belongs and provide 409 a segment call response including user segment information to the client device 106. Requesting and receiving user segment information may include similar steps as described above in connection with FIG. 3. Additionally, making a segment call may include requesting user segment information specific to one or multiple content publishers indicating one or more marketing campaigns for which the user has received a maximum quantity of marketing content from the specific publisher and/or for a particular marketing campaign. For example, a user segment may identify a marketing campaign for which the user 108 has received a maximum allowable quantity of marketing content. Additionally, a user segment may identify a specific content publisher within a marketing content for which the user 108 has received a maximum allowable quantity of marketing content, even if the user 108 is still below a maximum allowable quantity of marketing content for other content publishers within the same marketing campaign. Additionally, similar to the process described above in connection with FIGS. 3A-3B, the first content server 104a may provide 410 media content to the user 108 via the client device 106.

Additionally, prior to, subsequent to, or while receiving media content from the first content server 104a, the client device 106 can make 411 an ad call to the server device 101. In particular, the client device 106 may request an advertisement from an ad server 401 implemented on the server device 101. The ad call may include received segment information provided to the server device 101. Alternatively, the client device 106 may make an ad call without providing segment information. In response, the ad server 401 may identify any number of advertisements corresponding to various user segments that indicate the user 108 has received the maximum allowable quantity of marketing content corresponding to a particular marketing campaign and/or a particular content publisher.

Further, as illustrated in FIG. 4A, the server device 101 can provide 412 marketing content to the client device 106. In particular, the ad server 401 can provide the marketing content in conjunction with digital media from the first content server 104a. Providing marketing content may include similar steps and features as described above in connection with FIGS. 3A-3B. Additionally, in one or more embodiments, the ad server 401 can embed one or more tracking elements (e.g., tracking URLs, tracking pixel) within tracking calls provided to the client device 106 in conjunction with the marketing content.

In response to receiving the marketing content, the client device 106 can provide 414 a tracking call to the marketing system 102 to indicate receipt of the marketing content from the first content server 104a. In particular, a plugin on the first client device 106a may interact with the marketing system 102 and facilitate the client device 106 providing a tracking call to the marketing system 102 that indicates receipt of the marketing content. The tracking call may include information associated with the marketing content received by the user 108 as well as identifying information of the user 108 and the first publisher. For example, the tracking call may include an embedded tracking element (e.g., a tracking URL) that includes a custom visitor ID, a content publisher ID, a first device ID, an advertisement identifier and a quantity that represents a portion of the budget for the marketing campaign for the advertisement viewed on the client device 106. Additionally, the client device 106 can provide another tracking call including tracking elements for inclusion within the first publishers account on the marketing system 102.

The marketing system 102 can further update 416 a total quantity of marketing content that the user 108 has received based on the received tracking call. For example, the marketing system 102 can add to a running total of tracking elements for a particular marketing campaign and/or content publisher and assign or otherwise associate the user 108 with a user segment based for a trait based on a number of calls, number of advertisements, or other quantity value associated with the marketing content that the user 108 has received.

Additionally, as illustrated in FIG. 4B, the user may navigate to another website associated with a different publisher by logging on 418 to a second publisher's website using the client device 106. In response, the second content server 104b can provide an identification of the user 108 (e.g., a second publisher specific identifier) to the marketing system 102. Further, the client device 106 can make 420 a segment call to the server device 101. In response, the server device 101 may provide 421 a segment call response including user segment information assigned or otherwise associated with the user 108 to the client device 106. The second content server 104b may further provide 422 media content to the client device. Additionally, prior to, subsequent to, or while receiving media content, the client device 106 may make 423 an ad call to the server device 101. If the user 108 has not received the maximum quantity of marketing content for the marketing campaign, the server device 101 can provide 424 the marketing content to the client device 106 in conjunction with digital media from the second content server 104b (e.g., from the second content publisher's web site).

In response to receiving the marketing content, the client device 106 can make 426 a tracking call to the server device 101 to indicate receipt of the marketing content from the second content server 104b. Similar to other tracking calls mentioned above, the tracking call may include information associated with the marketing content received by the user 108 as well as identifying information of the user 108 and the second publisher. For example, the tracking call may be invoked by an embedded tracking element (e.g., a tracking URL) that includes a custom visitor ID, a content publisher ID, a device ID, an advertisement identifier and a quantity that represents a portion of the budget for the marketing campaign for the advertisement viewed on the client device 106. Additionally, the client device 106 can provide another tracking call including one or more tracking elements and information to include within the content publisher's account.

As illustrated in FIG. 4B, the marketing system 102 can update 428 a quantity of marketing content that the user 108 has received. For example, in response to receiving the tracking call from the client device 106, the marketing system 102 can add to a running total of tracking elements, associate the user 108 with a user segment for a campaign trait, or otherwise track the total quantity of marketing content that the user 108 has received.

Further, as illustrated in FIG. 4B, the marketing system 102 can identify 430 that the user 108 has received a maximum quantity of marketing content that the user 108 is permitted to receive. For example, the marketing system 102 can determine that a campaign trait for a user segment to which the user 108 belongs prevents the user 108 from receiving any additional marketing content for the marketing campaign. Further, the marketing system 102 can prevent 432 the user 108 from receiving any additional marketing content for the marketing campaign. For example, the marketing system 102 can assign the user 108 to a user segment for which the user 108 will no longer receive additional advertisements for the marketing campaign.

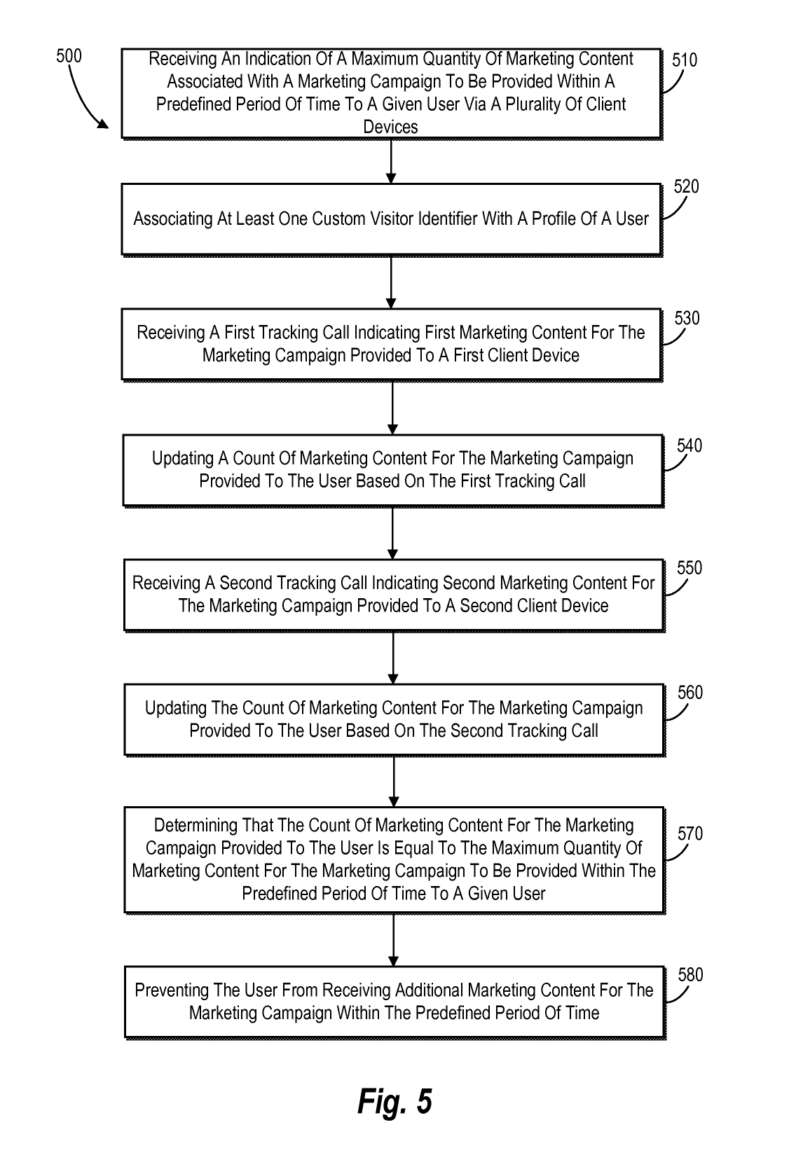

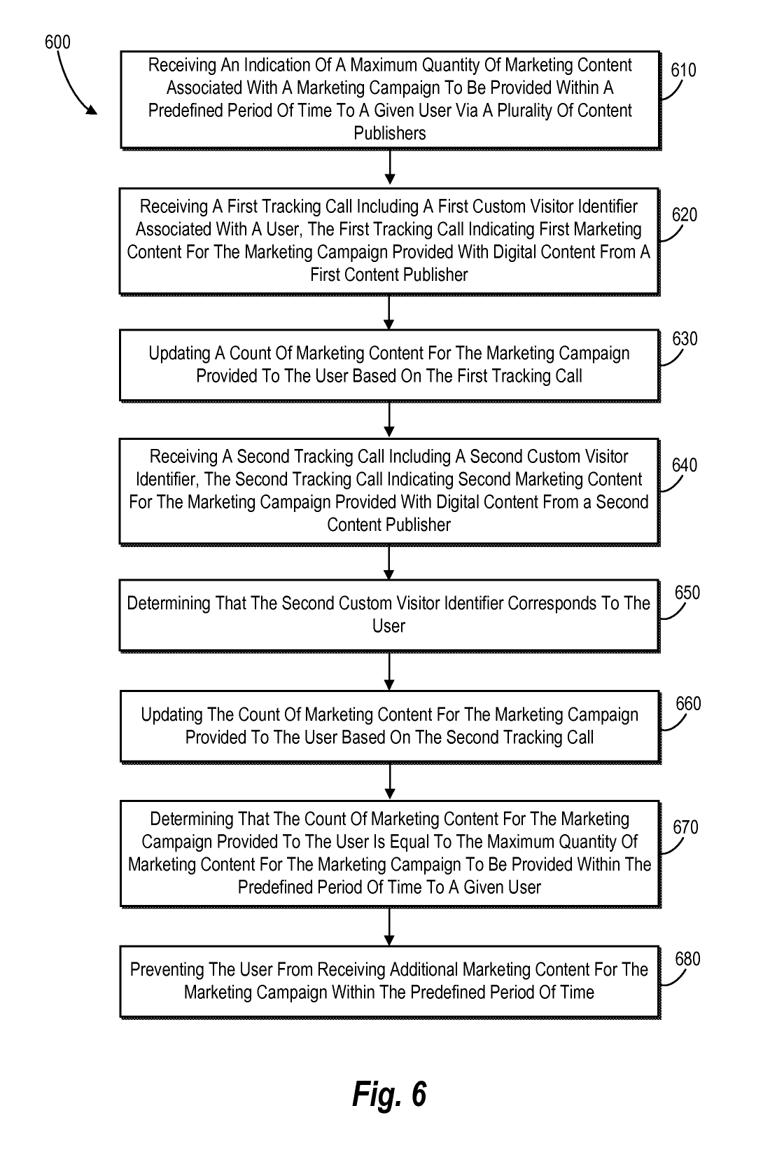

FIGS. 1-4B, the corresponding text, and the examples, provide a number of different systems and devices for limiting a total quantity of marketing content for a marketing campaign that is provided to a user. In addition to the foregoing, one or more embodiments can also be described in terms of flowcharts comprising acts and steps in a method for accomplishing a particular result. For example, FIGS. 5 and 6 illustrate flowcharts of exemplary methods in accordance with one or more embodiments. The methods described in relation to FIGS. 5 and 6 may be performed with less or more steps/acts or the steps/acts may be performed in differing orders. Additionally, the steps/acts described herein may be repeated or performed in parallel with one another or in parallel with different instances of the same or similar steps/acts.

FIG. 5 illustrates a flowchart of one example method 500 of limiting a quantity of marketing content for a marketing campaign that a user may receive across multiple client devices. The method 500 includes an act 510 of receiving (e.g., at one or more servers) an indication of a maximum quantity of marketing content associated with a marketing campaign to be provided within a predefined period of time to a given user via a plurality of client devices. In one or more embodiments, the maximum quantity of marketing content may include a predetermined quantity of advertisements (e.g., a number of ads). Alternatively, the maximum quantity of marketing content may include a monetary costs where each advertisement associated with the marketing campaign has an assigned cost. Additionally, in one or more embodiments, the act 510 may involve calculating a count value for each advertisement by determining the highest common factor (HCF) of the assigned costs of the advertisements and dividing the assigned costs for a given advertisement by the HCF. Further, the act 510 may involve calculating the maximum count value for a given user by dividing the monetary cost by the HCF.

The method 500 can further include an act 520 of associating (e.g., by one or more servers) one or more custom visitor identifiers with a profile of a user. Additionally, the method 500 can include an act 530 of receiving, from a first client device (e.g., a personal computing device, a tablet computing device, mobile phone), a first tracking call indicating first marketing content (e.g., a video advertisement, overlay advertisement) for the marketing campaign consumed by the first client device. In particular, as used herein, a client device may consume marketing content by downloading, streaming, or otherwise receiving content from a content server, server device, and/or ad server and displaying, presenting, or otherwise providing the marketing content to a user of the client device to view, listen to, interact with, or otherwise experience the marketing content using the client device. In addition to marketing content, a client device may further consume other content such as, for example, media content received from a content server.

In one or more embodiments, the first client device may provide the tracking call in response to receiving the first marketing content from an ad server or a content publisher. The first tracking call may include the one or more custom visitor identifiers associated with the user. Additionally, the first tracking call may include an identifier of a first content publisher that provided the first marketing content to the first client device. The first tracking call may further include a unique device identifier corresponding to the first client device.

The method 500 may further include an act 540 of updating (e.g., by one or more servers) a count of marketing content for the marketing campaign provided to the user based on the first tracking call from the first client device. The act 540 may involve adding the count value for the first marketing content to a current total count for the user. Additionally, the act 540 may involve adding the count value for the first marketing content to a count for a content publisher providing media content in conjunction with the marketing content.

The method 500 may further include an act 550 of receiving, from a second client device (e.g., a personal computing device, a tablet computing device, mobile phone), a second tracking call indicating second marketing content (e.g., a video advertisement, an overlay advertisement) for the marketing campaign provided to the second client device. The second tracking call may include the one or more custom visitor identifiers associated with the user. The method 500 may further include an act 560 of updating (e.g., by one or more servers) the count of marketing content for the marketing campaign provided to the user based on the second tracking call from the second client device.

The method 500 may further include an act 570 of determining (e.g., by one or more servers) that the count of at least one type of marketing content for the marketing campaign provided to the user is equal to the maximum quantity of at least one type of marketing content for the marketing campaign to be provided within the predefined period of time to a given user. In one or more embodiments, determining that the count of at least one type of marketing content for the marketing campaign provided to the user is equal to the maximum quantity includes determining that a maximum quantity of video advertisements for the marketing campaign has been provided to the user. Alternatively, determining that the count of at least one type of marketing content for the marketing campaign provided to the user is equal to the maximum quantity includes determining that a maximum quantity of all types of advertisements for the marketing campaign has been provided to the user. In particular, as discussed above, a marketer can set a maximum dollar count, number, or other measurement of marketing content to provide to a particular user within a given time frame. The method 500 can determine if a count for a particular user has been met. For instance, in one or more embodiments overlay ads count as 0.2, video ads count as 1.0, and a total daily count per user can comprise 2.2. Act 570 can involve determining that a user has already totaled 2.2. In such instances, as described below, the method 500 can involve preventing the user from receiving any additional ads (i.e., both overlay ads and video ads) from the marketing campaign. In an alternative embodiment, act 570 can involve determining that the user has already totaled a count of 2.0. In such instance, the method 500 can involve preventing the user from receiving any additional video ads from the marketing campaign, but allowing the user to receive an additional overlay ad from the marketing campaign.

Additionally, in response to determining that the count of the at least one type of marketing content for the marketing campaign to be provided to the user is equal to the maximum quantity, the method 500 may include an act 580 of preventing (e.g., by one or more servers) the user from receiving additional marketing content for the marketing campaign within the predetermined period of time. For example, act 580 can involve causing, by the one or more servers, one or more devices to prevent the user from receiving additional marketing content of the at least one type of marketing content for the marketing campaign within the predefined period of time. In particular, causing one or more devices to prevent the user from receiving additional marketing content can comprise assigning the user a segment ID that when received by an ad server causes the ad server to select a certain type of marketing content from the marketing campaign (e.g., only overly ads or only video ads) or select no marketing content from the marketing campaign to serve to the user.

The act 580 may involve receiving a user segment call from the first or second client devices that includes at least one of the custom visitor identifier(s). The act 580 may further involve returning a segment ID to the first client device or the second client device indicating that the user associated with the custom visitor identifier(s) has received the maximum quantity of marketing content associated with the marketing campaign. The segment ID may be forwarded to an ad server from the first client device or the second client device as part of an advertisement call.

While not shown in FIG. 5, the method 500 may include an act of receiving a user segment call from the second client device. The user segment call may include the custom visitor identifier(s). Additionally, the method 500 may include an act of determining that the count of marketing content for the marketing campaign provided to the user is less than the maximum allowable quantity of marketing content for the marketing campaign to be provided within the predefined period of time to a given user. The method 500 may further include an act of returning a segment ID to the second client device indicating that the user associated with the custom visitor identifier(s) is eligible to receive marketing content associated with the marketing campaign. The segment ID may be forwarded to an ad server from the second client device as part of an advertisement call.

In one or more embodiments, the method 500 may include an act of receiving a user segment call from the first client device or the second client device. The user segment call may include the custom visitor identifier(s). The method 500 may further include an act of identifying a segment ID based on the count of marketing content for the marketing campaign provided to the user. The method 500 may further include an act of returning the identified segment ID to the first client device or the second client device. The segment ID may be forwarded to an ad server from the first or second client device as part of an advertisement call.

In one or more embodiments, method 500 may further include an act of creating a trait that indicates one or more user segments associated with a maximum quantity of marketing content for the marketing campaign. Further, as described above, in one or more embodiments, the act of determining that the total quantity of marketing content for the marketing campaign is equal to the maximum quantity of marketing content involves receiving a request for marketing content (e.g., from the user) and determining (e.g., in response to receiving the request) that the user has been assigned to a user segment of the one or more user segments indicating that nay user assigned to the user segment has received the maximum quantity of marketing content for the marketing campaign.

Further, in one or more embodiments, the method 500 may include an act of associating the unique device identifier corresponding to the first client device with the profile of the user. The method 500 may further include an act of receiving a third tracking call indicating third marketing content for the marketing campaign provided with third digital content for the marketing campaign provided with third digital content from a second content publisher, the third tracking call including a second custom visitor identifier and the unique device identifier corresponding to the first client device. The method 500 may further include an act of determining that the second custom visitor identifier corresponds to the user based on the third tracking call including the unique device identifier corresponding to the first client device. The method 500 may further include an act of updating the count of marketing content for the marketing campaign provided to the user based on the third tracking call.

FIG. 6 illustrates a flowchart of one example method 600 of limiting a quantity of marketing content for a marketing campaign that a user may receive from multiple publishers. The method 600 may include an act 610 of receiving (e.g., at one or more servers) an indication of a maximum quantity of marketing content associated with a marketing campaign to be provided within a predefined period of time to a given user via a plurality of content publishers. For example, the act 610 may involve receiving a maximum number of advertisements, a maximum monetary value associated with various advertisements, or a quantity of tracking elements associated with a marketing campaign.

The method 600 may further include an act 620 of receiving a first tracking call indicating first marketing content for the marketing campaign provided with digital content from a first content publisher. The first tracking call may include a first custom visitor identifier associated with a user. The first tracking call may further include a unique device identifier corresponding to a client device providing the first tracking call. Additionally, the method 600 may include an act 630 of updating (e.g., by one or more servers) a count of marketing content for the marketing campaign provided to the user based on the first tracking call. For example, the act 630 may involve updating a total quantity based on a number of tracking calls received.

The method 600 may further include an act 640 of receiving a second tracking call indicating second marketing content for the marketing campaign provided with digital content from a second content publisher. The second tracking call may include a second custom visitor identifier. The second tracking call may further include a unique device identifier corresponding to the client device providing the second tracking call. The method 600 may include an act 650 of determining (e.g., by one or more servers) that the second custom visitor identifier corresponds to the user. Additionally, the method 600 may include an act 660 of updating (e.g., by one or more servers) the count of marketing content for the marketing campaign provided to the user based on the second tracking call.

The method 600 may further include an act 670 of determining (e.g., by one or more servers) that the count of marketing content for the marketing campaign provided to the user is equal to the maximum quantity of marketing content for the marketing campaign to be provided within the predefined period of time to a given user. In response to determining that the count of marketing content for the marketing campaign provided to the user is equal to the maximum quantity of marketing content for the marketing campaign to be provided within the predefined period of time to a given user, the method 600 may include an act 680 of causing (e.g., by one or more servers) one or more devices to prevent the user from receiving additional marketing content for the marketing campaign within the predefined period of time. In particular, as used herein “causing” may refer to executing one or more instructions using a processor (e.g., on the one or more servers or client devices) to cause a device or multiple devices to perform one or more steps or processes. For example, causing a client device to prevent a user from receiving marketing content may include executing one or more instructions by a processor on the client device that would prevent the client device from requesting, receiving, or otherwise consuming marketing content to be experienced by a user.

Additionally, while not explicitly shown in FIG. 6, the method 600 may include an act of associating a first advertisement ID with the first marketing content. The first advertisement ID may be associated with the first content publisher. The method 600 may further include an act of associating a second advertisement ID with the second marketing content. The second advertisement ID may be associated with the second content publisher. The method 600 may further include an act of associating the first advertisement ID and the second advertisement ID with the marketing campaign.

Additionally, as mentioned above, the method 600 may include an act of determining that the second custom visitor identifier corresponds to the user. In one or more embodiments, this act of determining that the second custom visitor identifier corresponds to the user may involve associating the unique device identifier corresponding to the client device with the profile of the user. Additionally, this act may involve identifying that the second tracking call comprises the unique device identifier corresponding to the client device. Further, this act may involve identifying that the unique device identifier corresponding to the client device included with the second tracking call is associated with the profile of the user. Further, this act may involve associating the second custom visitor identifier with the profile of the user.

Additionally, while not explicitly shown in FIGS. 5 and 6, one or more embodiments of a method for limiting frequency of content provided to a user across multiple client devices may include receiving an indication of a maximum quantity of marketing content associated with a marketing campaign to be proceed within a predefined period of time to a given user via a plurality of client devices. Additionally, the method may include receiving a tracking call indicating marketing content for the marketing campaign consumed using the first client device, the tracking call also including at least one custom visitor identifier associated with the user. Further, the method may include updating a count of marketing content for the marketing campaign provided to the user based on the tracking call from the client device. Further, the method may include determining that the count of marketing content for the marketing campaign provided to the user is equal to the maximum quantity of marketing content for the marketing campaign to be provided within the predefined period of time to the user. Further, the method may include receiving (e.g., from a second client device, a request for one or more user segments associated with the user, the one or more user segments indicating that the user has received the maximum quantity of marketing content for a given marketing campaign. Further, the method may include providing a response to the request, the response including an indication that the user has received the maximum quantity of marketing content for the marketing campaign. Further, the method may include receiving (e.g., from the second client device) an ad call requesting marketing content to be provided to the second client device, the ad call including the indication that the user has received the maximum quantity of marketing content for the marketing campaign. Further, in response to receiving the indication that the user has received the maximum quantity of marketing content for the marketing campaign, the method may include selecting marketing content from a different marketing campaign for which the user has not received the maximum quantity of marketing content to provide to the second client device.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In one or more embodiments, computer-executable instructions are executed on a general purpose computer to turn the general purpose computer into a special purpose computer implementing elements of the disclosure. The computer executable instructions may be, for example, binaries, intermediate format instructions such as assembly language, or even source code. Although the subject matter has been described in language specific to structural marketing features and/or methodological acts, it is to be understood that the subject matter defined in the appended claims is not necessarily limited to the described marketing features or acts described above. Rather, the described marketing features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as an unsubscription model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing un-subscription model can be composed of various characteristics such as, for example, on-demand self-service, broad network access, resource pooling, rapid elasticity, measured service, and so forth. A cloud-computing un-subscription model can also expose various service un-subscription models, such as, for example, Software as a Service (“SaaS”), Platform as a Service (“PaaS”), and Infrastructure as a Service (“IaaS”). A cloud-computing un-subscription model can also be deployed using different deployment un-subscription models such as private cloud, community cloud, public cloud, hybrid cloud, and so forth. In this description and in the claims, a “cloud-computing environment” is an environment in which cloud computing is employed.

FIG. 7 illustrates a block diagram of an exemplary computing device 700 that may be configured to perform one or more of the processes described above. One will appreciate that the server device 101, one or more content servers 104a-b, and one or more client devices 106a-c may be implemented by one or more computing devices such as the computing device 700. As shown by FIG. 7, the computing device 700 can comprise a processor 702, memory 704, a storage device 706, an I/O interface 708, and a communication interface 710, which may be communicatively coupled by way of a communication infrastructure 712. While an exemplary computing device 700 is shown in FIG. 7, the components illustrated in FIG. 7 are not intended to be limiting. Additional or alternative components may be used in other embodiments. Furthermore, in certain embodiments, the computing device 700 can include fewer components than those shown in FIG. 7. Components of the computing device 700 shown in FIG. 7 will now be described in additional detail.

In particular embodiments, the processor 702 includes hardware for executing instructions, such as those making up a computer program. As an example and not by way of limitation, to execute instructions, the processor 702 may retrieve (or fetch) the instructions from an internal register, an internal cache, the memory 704, or the storage device 706 and decode and execute them. In particular embodiments, the processor 702 may include one or more internal caches for data, instructions, or addresses. As an example and not by way of limitation, the processor 702 may include one or more instruction caches, one or more data caches, and one or more translation lookaside buffers (TLBs). Instructions in the instruction caches may be copies of instructions in the memory 704 or the storage 706.

The memory 704 may be used for storing data, metadata, and programs for execution by the processor(s). The memory 704 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 704 may be internal or distributed memory.

The storage device 706 includes storage for storing data or instructions. As an example and not by way of limitation, the storage device 706 can comprise a non-transitory storage medium described above. The storage device 706 may include a hard disk drive (HDD), a floppy disk drive, flash memory, an optical disc, a magneto-optical disc, magnetic tape, or an universal Serial Bus (USB) drive or a combination of two or more of these. The storage device 706 may include removable or non-removable (or fixed) media, where appropriate. The storage device 706 may be internal or external to the computing device 700. In particular embodiments, the storage device 706 is non-volatile, solid-state memory. In other embodiments, the storage device 706 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 708 allows a user to provide input to, receive output from, and otherwise transfer data to and receive data from the computing device 700. The I/O interface 708 may include a mouse, a keypad or a keyboard, a touch screen, a camera, an optical scanner, network interface, modem, other known I/O devices or a combination of such I/O interfaces. The I/O interface 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 708 is configured to provide graphical data to a display for presentation to a user. The graphical data may be representative of one or more graphical user interfaces and/or any other graphical content as may serve a particular implementation.

The communication interface 710 can include hardware, software, or both. In any event, the communication interface 710 can provide one or more interfaces for communication (such as, for example, packet-based communication) between the computing device 700 and one or more other computing devices or networks. As an example and not by way of limitation, the communication interface 710 may include a network interface controller (NIC) or network adapter for communicating with an Ethernet or other wire-based network or a wireless NIC (WNIC) or wireless adapter for communicating with a wireless network, such as a WI-FI.

Additionally or alternatively, the communication interface 710 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 710 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 710 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) calling technologies, Long Term Evolution (“LTE”) technologies, wireless communication technologies, in-band and out-of-band calling technologies, and other suitable communications networks and technologies.

The communication infrastructure 712 may include hardware, software, or both that couples components of the computing device 700 to each other. As an example and not by way of limitation, the communication infrastructure 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. In a digital medium environment for communicating marketing electronic content dynamically to a user via multiple client devices, a method for limiting frequency of content provided to the user across the multiple client devices in the digital medium environment, comprising:
receiving, at one or more servers, an indication of a maximum quantity of marketing content associated with a marketing campaign to be provided within a predefined period of time to the user via a plurality of client devices;
receiving, from a first client device of the user, a first tracking call indicating first marketing content for the marketing campaign consumed using the first client device, the first tracking call also including at least one custom visitor identifier associated with the user;
updating, by the one or more servers, a count of marketing content for the marketing campaign provided to the user based on the first tracking call from the first client device;
receiving, from a second client device, a second tracking call indicating second marketing content for the marketing campaign consumed using the second client device, the second tracking call including the at least one custom visitor identifier associated with the user;
updating, by the one or more servers, the count of marketing content for the marketing campaign provided to the user based on the second tracking call from the second client device;
determining, by the one or more servers, that the count of at least one type of marketing content for the marketing campaign provided to the user is equal to the maximum quantity of the at least one type of marketing content for the marketing campaign to be provided within the predefined period of time to the user; and
in response to determining that the count of the at least one type of marketing content for the marketing campaign provided to the user is equal to the maximum quantity of the at least one type of marketing content for the marketing campaign to be provided within the predefined period of time to the user, causing, by the one or more servers, one or more devices to prevent the user from receiving additional marketing content of the at least one type of marketing content for the marketing campaign within the predefined period of time.

2. The method as recited in claim 1, wherein causing by the one or more servers, one or more devices to prevent the user from receiving additional marketing content of the at least one type of marketing content for the marketing campaign within the predefined period of time comprises:
receiving a user segment call from the first client device or the second client device, the user segment call including the at least one custom visitor identifier; and
returning a segment ID to the first client device or the second client device indicating that the user associated with the at least one custom visitor identifier has received the maximum quantity of marketing content associated with the marketing campaign, the segment ID to be forward to an ad server from the first client device or the second client device as part of an advertisement call.

3. The method as recited in claim 1, further comprising:
receiving a user segment call from the second client device, the user segment call including the at least one custom visitor identifier; and
determining, by the one or more servers, that the count of marketing content for the marketing campaign provided to the user is less than the maximum quantity of marketing content for the marketing campaign to be provided within the predefined period of time to the user; and
returning a segment ID to the second client device indicating that the user associated with the at least one custom visitor identifier is eligible to receive marketing content associated with the marketing campaign, the segment ID to be forward to an ad server from the second client device as part of an advertisement call.

4. The method as recited in claim 1:
wherein determining that the count of the at least one type of marketing content of marketing content for the marketing campaign provided to the user is equal to the maximum quantity comprises determining that a maximum quantity of video advertisements for the marketing campaign has been provided to the user; and
wherein causing, by the one or more servers, one or more devices to prevent the user from receiving additional marketing content of the at least one type of marketing content for the marketing campaign comprises causing the one or more devices to prevent the user from receiving additional video advertisements for the marketing campaign while permitting the user to receive one or more alternative types of marketing content for the marketing campaign.

5. The method as recited in claim 1, wherein:
the maximum quantity of marketing content associated with the marketing campaign to be provided within the predefined period of time to the user comprises a monetary cost; and
each advertisement associated with the marketing campaign has an assigned cost.

6. The method as recited in claim 5, further comprising:
calculating a count value for each advertisement by determining the highest common factor of the assigned costs of the advertisements associated with the marketing campaign and dividing the assigned costs for an advertisement by the highest common factor; and
calculating a maximum count value for the user by dividing the monetary cost by the highest common factor.

7. The method as recited in claim 1, wherein updating, by the one or more servers, the count of marketing content for the marketing campaign provided to the user based on the first tracking call from the first client device comprises adding the count value for the first marketing content to a current total count for the user.

8. The method as recited in claim 1, further comprising:
receiving a user segment call from the first client device or the second client device, the user segment call including the at least one custom visitor identifier;
identifying a segment ID based on the count of marketing content for the marketing campaign provided to the user; and
returning the identified segment ID to the first client device or the second client device, the segment ID to be forward to an ad server from the first client device or the second client device as part of an advertisement call.

9. The method as recited in claim 1, further comprising:
creating a trait that indicates one or more user segments associated with a maximum quantity of marketing content for the marketing campaign;
determining, by the one or more servers, that the count of at least one type of marketing content for the marketing campaign provided to the user is equal to the maximum quantity of the at least one type of marketing content for the marketing campaign to be provided within the predefined period of time to the user comprises:
receiving, from the user, a request for marketing content;
determining, in response to receiving the request, that the user has been assigned to a user segment of the one or more user segments indicating that any user assigned to the user segment has received the maximum quantity of marketing content for the marketing campaign.

10. The method as recited in claim 1, wherein:
the first client device comprises a tablet computing device; and
the second client device comprises a mobile phone.

11. The method as recited in claim 1, wherein:
the first marketing content comprises a video advertisement; and
the second marketing content comprises an overlay advertisement.

12. The method as recited in claim 1, wherein the first tracking call comprises:
an identifier of a first content publisher that provided the first marketing content to the first client device; and
a unique device identifier corresponding to the first client device.

13. The method as recited in claim 1, further comprising:
associating the unique device identifier corresponding to the first client device with the profile of the user;
receiving a third tracking call indicating third marketing content for the marketing campaign provided with third digital content from a second content publisher, the third tracking call including a second custom visitor identifier and the unique device identifier corresponding to the first client device;
determining that the second custom visitor identifier corresponds to the user based on the third tracking call including the unique device identifier corresponding to the first client device; and
updating the count of marketing content for the marketing campaign provided to the user based on the third tracking call.

14. In a digital medium environment for communicating electronic marketing content dynamically to a user via multiple content publishers, a method for limiting frequency of content provided to the user across the multiple content publishers in the digital medium environment, comprising:
receiving, at one or more servers, an indication of a maximum quantity of marketing content associated with a marketing campaign to be provided within a predefined period of time to the user via a plurality of content publishers;
receiving a first tracking call indicating first marketing content for the marketing campaign provided with digital content from a first content publisher, the first tracking call including a first custom visitor identifier associated with the user;
updating, by the one or more servers, a count of marketing content for the marketing campaign provided to the user based on the first tracking call;
receiving a second tracking call indicating second marketing content for the marketing campaign provided with digital content from a second content publisher, the second tracking call including a second custom visitor identifier;
determining, by the one or more servers, that the second custom visitor identifier corresponds to the user;
updating, by the one or more servers, the count of marketing content for the marketing campaign provided to the user based on the second tracking call;
determining, by the one or more servers, that the count of at least one type of marketing content for the marketing campaign provided to the user is equal to the maximum quantity of marketing content of the at least one type of marketing content for the marketing campaign to be provided within the predefined period of time to the user; and
in response to determining that the count of the at least one type of marketing content for the marketing campaign provided to the user is equal to the maximum quantity of marketing content of the at least one type for the marketing campaign to be provided within the predefined period of time to the user, preventing, by the one or more servers, the user from receiving additional marketing content of the at least one type for the marketing campaign within the predefined period of time.

15. The method as recited in claim 14, further comprising:
associating a first advertisement ID with the first marketing content, the first advertisement ID being associated with the first content publisher;
associating a second advertisement ID with the second marketing content, the second advertisement ID being associated with the second content publisher; and
associating the first advertisement ID and the second advertisement ID with the marketing campaign.

16. The method as recited in claim 14, wherein:
the first tracking call further comprises a unique device identifier corresponding to a client device providing the first tracking call and the second tracking call; and
the second tracking call further comprises the unique device identifier corresponding to the client device.

17. The method as recited in claim 16, wherein determining, by the one or more servers, that the second custom visitor identifier corresponds to the user comprises:
associating the unique device identifier corresponding to the client device with the profile of the user;
identifying that the second tracking call comprises the unique device identifier corresponding to the client device;
identifying that the unique device identifier corresponding to the client device included with the second tracking call is associated with the profile of the user; and
associating the second custom visitor identifier with the profile of the user.

18. In a digital medium environment for communicating marketing electronic content dynamically to a user via multiple client devices, a method for limiting frequency of content provided to the user across the multiple client devices in the digital medium environment, comprising:
receiving, at one or more servers, an indication of a maximum quantity of marketing content associated with a marketing campaign to be proceed within a predefined period of time to a given user via a plurality of client devices;
receiving, from a first client device used by a user to consume marketing content for the marketing campaign, a tracking call indicating marketing content for the marketing campaign consumed using the first client device, the tracking call also including at least one custom visitor identifier associated with the user;
updating, by the one or more servers, a count of marketing content for the marketing campaign provided to the user based on the tracking call from the first client device;
determining, by the one or more servers, that the count of marketing content for the marketing campaign provided to the user is equal to the maximum quantity of marketing content for the marketing campaign to be provided within the predefined period of time to the user;
receiving, from a second client device, a request for one or more user segments associated with the user, the one or more user segments indicating that the user has received the maximum quantity of marketing content for a given marketing campaign;
providing, by the one or more servers, a response to the request, the response including an indication that the user has received the maximum quantity of marketing content for the marketing campaign;
receiving, from the second client device, an ad call requesting marketing content to be provided to the second client device, the ad call including the indication that the user has received the maximum quantity of marketing content for the marketing campaign;
in response to receiving the indication that the user has received the maximum quantity of marketing content for the marketing campaign, selecting, by the one or more servers, marketing content from a different marketing campaign for which the user has not received the maximum quantity of marketing content to provide to the second client device.

19. The method of claim 18, wherein:
the tracking call further comprises a unique device identifier corresponding to the first client device; and
wherein the first marketing content is provided to the first client device with content from a first content publisher.

20. The method of claim 19, further comprising:
associating the unique device identifier corresponding to the first client device with the profile of the user;
receiving a second tracking call indicating marketing content for the different marketing campaign consumed using the second client device, the second tracking call including a second custom visitor identifier and a unique device identifier corresponding to the second client device ; and
updating a count of marketing content for the different marketing campaign provided to the user based on the second tracking call.
